(19) United States
(12) Patent Application Publication
(10) Pub. No.: US 2013/0177021 A1
(43) Pub. Date: Jul. 11, 2013

(54) COMMUNICATION DEVICE, COMMUNICATION SYSTEM AND COMMUNICATION METHOD

(71) Applicants: Kenji Kitayama, Tokyo (JP); Kazuyuki Kashima, Tokyo (JP)

(72) Inventors: Kenji Kitayama, Tokyo (JP); Kazuyuki Kashima, Tokyo (JP)

(73) Assignee: Mitsubishi Electric Corporation, Tokyo (JP)

(21) Appl. No.: 13/824,016

(22) PCT Filed: Dec. 21, 2010
(86) PCT No.: PCT/JP10/73049

§ 371 Date: Mar. 15, 2013

(51) Int. Cl. H04L 12/423

(52) U.S. Cl. CPC H04L 12/423
USPC 370/392

(57) ABSTRACT

A node functions as an inter-ring connection node connected to an inter-ring connection link in a communication system including a plurality of inter-ring connection links connected between adjacent ring networks. The node includes: a flow-information-pass determination unit that decides which of the inter-ring connection links a reception frame passes through, based on flow information that is stored in the frame for identifying flow to which the frame belongs; and a forwarding-destination-port decision unit that decides that a forwarding destination of the reception frame is an inter-ring connection link to which the own node is connected when the inter-ring connection link decided by the flow-information-pass determination unit is the inter-ring connection link to which the own node is connected, in the case where a destination of the reception frame is in an adjacent ring network.

### FIELD

The present invention relates to a communication device that configures a ring network.

Standardization of Ethernet (Registered Trademark) Ring Protection (hereinafter, ERP) to be used as a ring-control protocol system for a ring network has been considered in ITU-T G.8032 (see Non Patent Literature 1 mentioned below). In the ERP, a bidirectional double ring is formed and a master/slave control is performed, in which nodes are divided into a master node (a Ring Protection Link (RPL) owner) and slave nodes (non RPL owners) and perform respective operations.

In a normal network having no failure, the RPL owner avoids a loop by setting a blocking point (BP) to any one of ports of its own node and discarding a transmission/reception traffic in such a BP set port. Each of the nodes monitors a link failure of the adjacent nodes, a node that has detected a failure sets a BP to a failure port, the RPL owner having received failure information cancels the BP setting of its own node, and all the nodes on the network autonomously perform flush (deletion) of table entries in a forwarding database (FDB) for learning addresses of nodes on the network. By performing this operation, the ERP realizes a function that enables to switch a communication path at the time of failure (a failure circumvention function or protection function at the time of ring failure).

Functions of the RPL owner and the non RPL owner in the ERP described above are explained next.

### (1) Ring Configuration

To prevent occurrence of a loop frame in an Ethernet ring, a BP is set to at least one position in the ring without question. The BP is usually set to any one of ports of the RPL owner.

### (2) Frame Transmission/Reception

At a BP set port, both of a control frame and a data frame are discarded. At a BP unset port, both of a control frame and a data frame are allowed to be forwarded.

### (3) Failure Path Switching

Upon failure detection using a Continuity Check Message (CCM) frame and failure notification using a Ring Automatic Protection Switching (R-APS) frame, address relearning is performed at the time of failure and FDB flush is performed to implement path switching. At the time of failure recovery, the RPL owner starts a Wait To Restore (WTR) timer to monitor a recovery state for a certain period of time based on a recovery notification using an R-APS (No Request (NR)) frame (NR message) from a node that has detected recovery from the failure. After the timer reaches the certain time, the RPL owner resets a BP to its own port, then performs FDB flush of its own node, and notifies all the nodes of an R-APS (NR, RB) frame (NR, RB) (Ring Blocked) message). The non-RPL owners having received this frame perform FDB flush, and a BP set node cancels the BP setting.

Meanwhile, because of increase in size of the network, a multi-ring network in which a plurality of ring networks (single rings) of L2 (Layer 2) are connected with each other has been studied. For example, an inter-ring connection node is provided for each of rings (ring networks), and connection is made between the inter-ring connection nodes of different rings as a ring connection link, thereby connecting the rings. When the rings are to be connected with high reliability, there is adopted a configuration in which the inter-ring connection nodes connecting the rings are redundantly provided, that is, with which a number of ring connection links are equipped.

### CITATION LIST

### Non Patent Literature

Non Patent Literature 1: ITU-T “Draft Recommendation G.8032/Y.1344 version 2 Ethernet Ring Protection Switching”, 2009

### SUMMARY

### Technical Problem

However, when the ring control protocol in the single ring of the conventional technique is applied to the configuration that has redundancy in the inter-ring connection nodes, the following problems occur. For example, when two or more sets of inter-ring connection nodes are provided for redundancy and the two or more pairs of inter-ring connection nodes are used at the same time, a frame forwarded by an inter-ring connection node arrives at an inter-ring connection node of a forwarding destination ring, then is transmitted to both ring ports by Flooding, and arrives at another inter-ring connection node in the same ring. This inter-ring connection node forwards the frame by similarly Flooding to the other ring port on the opposite side to a reception side and an inter-ring connection port for connection to an inter-ring connection node connected with the node itself by the inter-ring connection link. Accordingly, the frame is flowed back to a forwarding source ring, resulting in a loop frame. When a loop frame phenomenon occurs, a broadcast storm occurs and a usable band is considerably reduced in the entire multi-ring network, thereby leading to influences of reduction in communication throughput and the like.

Furthermore, when two or more sets of inter-ring connection nodes are used at the same time, there are required a plurality of communication paths to a destination node passing between the rings. Accordingly, an inter-ring connection node forwards a frame having received at a ring port by Flooding to the other ring port (which is not on the reception side) and to an inter-ring connection port. When an inter-ring connection node downstream of the relevant inter-ring connection nodes further performs forwarding by Flooding in the same manner as mentioned above, a plurality of the same frames are forwarded to the adjacent ring through a plurality of ring connection links. Therefore, double arrival of the frame occurs at the adjacent ring.

Meanwhile, to avoid the problems mentioned above, permission of forwarding to an inter-ring connection link by one pair of the plural pairs of inter-ring connection nodes is conceivable. In this case, however, there are ring connection links that are not used and a band use efficiency is decreased.

The present invention has been achieved in view of these problems, and an object of the present invention is to provide a communication device, a communication system, and a communication method, that enable to enhance a band use efficiency and also prevent occurrence of the loop frame and the double arrival of a frame when equipping themselves with plural pairs of inter-ring connection nodes.

To solve the above problems and achieve the object, the present invention provides a communication device that functions in a communication system including a plurality of inter-ring connection links that each connect between adjacent ring networks, as an inter-ring connection node connected to the inter-ring connection link, the communication device comprising: a pass-link decision unit that, based on flow information that is stored in a reception frame for identifying a flow to which the frame belongs, decides which of the inter-ring connection links the frame passes through; and a forwarding-destination decision unit that, in the case where a destination of the reception frame is in an adjacent ring network, when the inter-ring connection link decided by the pass-link decision unit is an inter-ring connection link to which an own node is connected, decides that a forwarding destination of the frame is the inter-ring connection link to which the own node is connected.

### Advantageous Effects of Invention

According to the present invention, band use efficiency can be enhanced and also occurrence of a loop frame and double arrival of a frame can be prevented when plural pairs of inter-ring connection nodes are provided.

### BRIEF DESCRIPTION OF DRAWINGS

FIG. 1 is an illustration showing a configuration example of a communication system according to a first embodiment.

FIG. 2 is a diagram showing a functional configuration example of a node according to the first embodiment.

FIG. 3 is an illustration showing a configuration example of a communication system to which terminals are connected.

FIG. 4 is a listing showing one example of an inter-ring pass determination result in the first embodiment.

FIG. 5 is an illustration showing one example of Flooding flows.

FIG. 6 is a flowchart showing one an example of an FDB learning procedure in an inter-ring connection node according to the first embodiment.

FIG. 7 is a listing showing one example of an FDB configuration according to the first embodiment.

FIG. 8 is a flowchart showing one example of an L2 forwarding procedure in the inter-ring connection node according to the first embodiment.

FIG. 9 is a table showing one example of an FDB learning state of nodes according to the first embodiment.

FIG. 10 is an illustration showing one example of a communication path between a terminal 7-1 and a terminal 7-2.

FIG. 11 is an illustration showing one example of a communication path between the terminal 7-1 and a terminal 7-3.

FIG. 12 is an illustration showing one example of a communication path between the terminal 7-1 and a terminal 7-4.

FIG. 13 is an illustration showing one example of a communication path between the terminal 7-1 and a terminal 7-5.

FIG. 14 is a diagram showing a functional configuration example of an inter-ring connection node according to a second embodiment.

FIG. 15 is a flowchart showing one example of an FDB learning procedure in the inter-ring connection node according to the second embodiment.

FIG. 16 is a table showing a configuration example of an FDB according to the second embodiment.

FIG. 17 is a flowchart showing one example of an L2 forwarding procedure according to the second embodiment.

FIG. 18 is a table showing one example of an FDB learning state according to the second embodiment.

FIG. 19 is a table showing one example of the FDB learning state according to the second embodiment.

FIG. 20 is a table showing one example of the FDB learning state according to the second embodiment.

FIG. 21 is a table showing one example of the FDB learning state according to the second embodiment.

FIG. 22 is an illustration showing a configuration example of a communication system according to a third embodiment.

FIG. 23 is an illustration showing a configuration example of a communication system in which a BP is set to an inter-ring connection node.

FIG. 24 is a flowchart showing one example of an L2 forwarding procedure when a failure occurs in an inter-ring connection link according to the third embodiment.

FIG. 25 is a flowchart of an example of an FDB-flush-performance determination processing procedure.

### DESCRIPTION OF EMBODIMENTS

Embodiments of a communication device, a communication system, and a communication method according to the present invention will be described below in detail with reference to the drawings. The present invention is not limited to the embodiments.

### First Embodiment

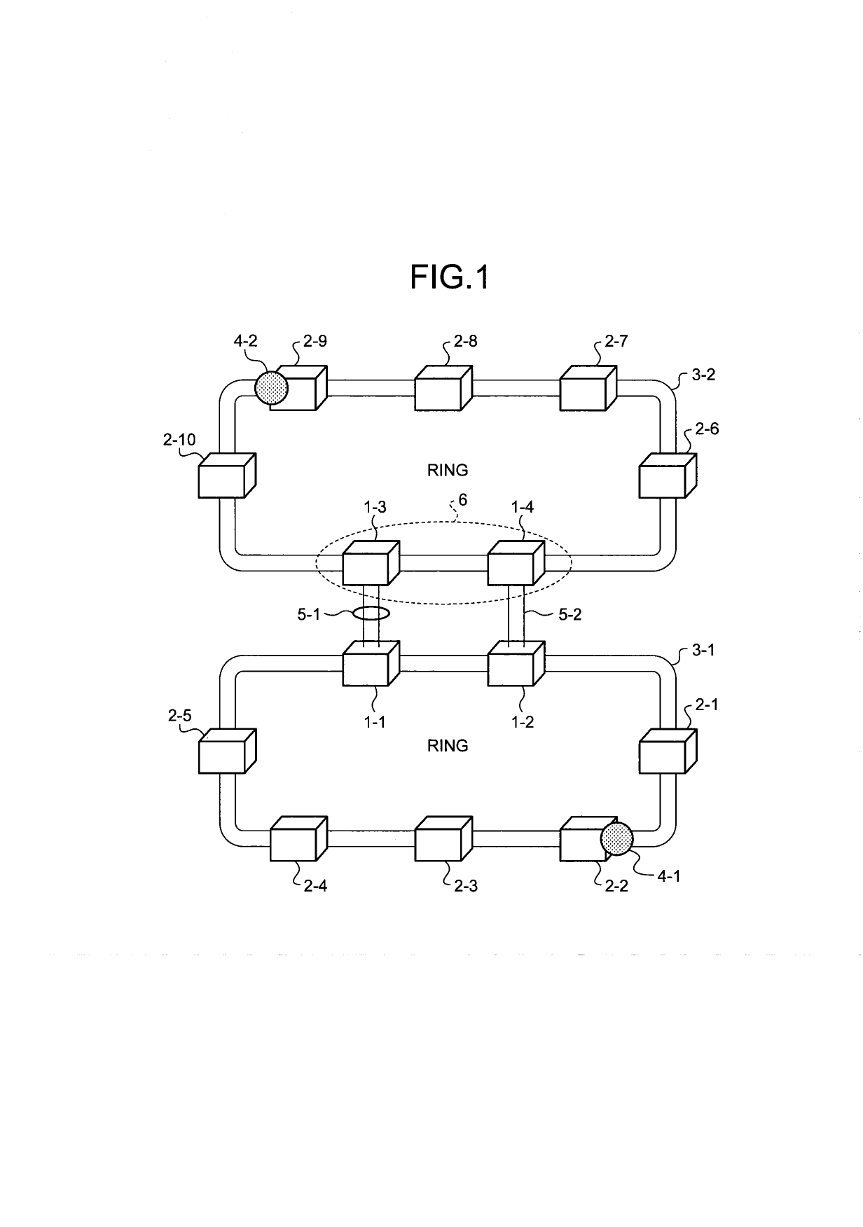

FIG. 1 is an illustration showing a configuration example of a communication system according to a first embodiment of the present invention. As shown in FIG. 1, the communication system according to the present embodiment includes nodes (communication devices) 1-1 to 1-4 and 2-1 to 2-10. The nodes 1-1 and 1-2 and the nodes 2-1 to 2-5 constitute a ring network (hereinafter, “ring”) 3-1 and the nodes 1-3 and 1-4 and the nodes 2-6 to 2-10 constitute a ring 3-2. A BP 4-1 is set to the node 2-2 in the ring 3-1, and a BP 4-2 is set to the node 2-9 in the ring 3-2.

The nodes 1-1 to 1-4 are inter-ring connection nodes that connect the rings 3-1 and 3-2. The nodes 1-1 and 1-3 are connected by an inter-ring connection link (hereinafter, “link”) 5-1, and the nodes 1-2 and 1-4 are connected by an inter-ring connection link (link) 5-2. The nodes 1-3 and 1-4 constitute a redundant pair 6 in the ring 3-2.

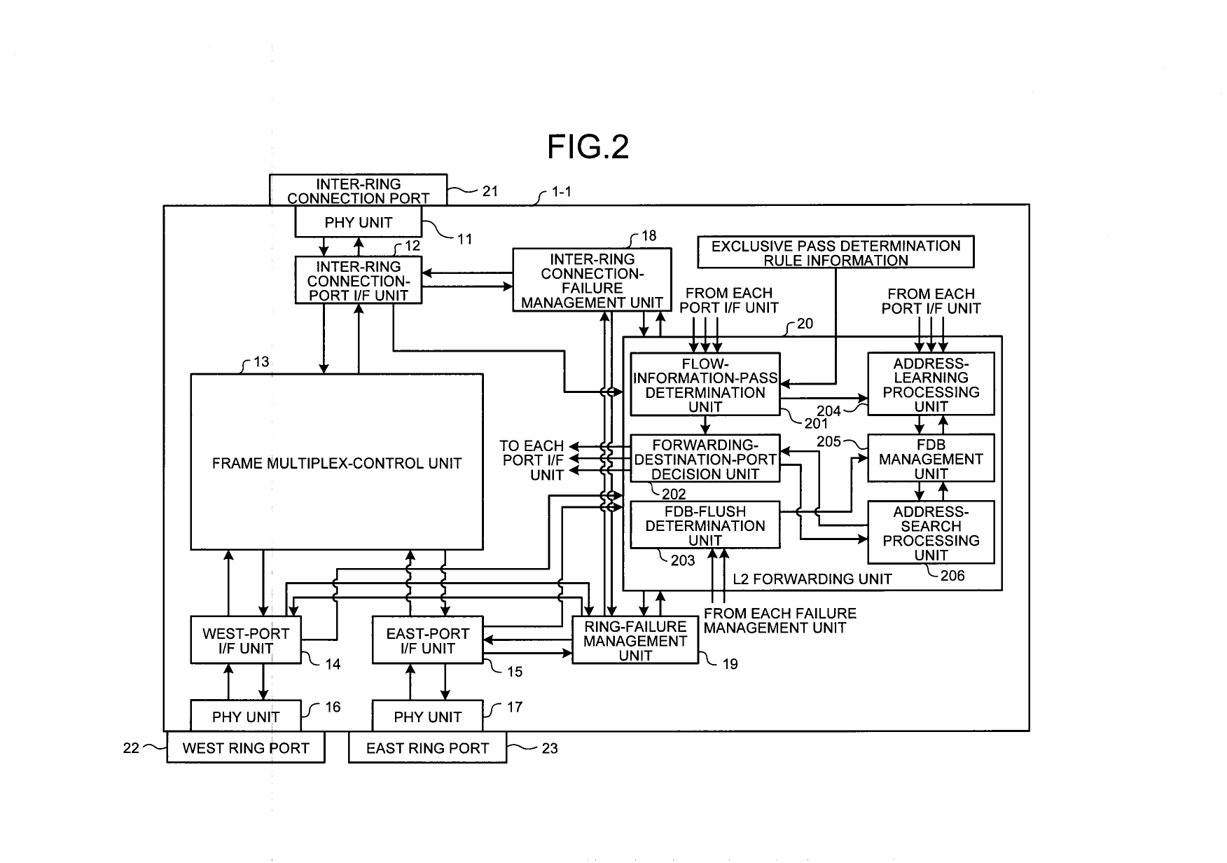

FIG. 2 is a functional configuration example of the node 1-1. Configurations of the nodes 1-2 and 1-3 are the same as that of the node 1-1. As shown in FIG. 2, the node 1-1 includes a PHY unit 11, an inter-ring connection-port interface (I/F) unit 12, a frame multiplex-control unit 13, a West-port I/F unit 14, an East-port I/F unit 15, PHY units 16 and 17, an inter-ring connection-failure management unit 18, a ring-failure management unit 19, an L2 forwarding unit 20, an inter-ring connection port 21, a West ring port 22, and an East ring port 23.

The L2 forwarding unit 20 includes a flow-information-pass determination unit (pass-link decision unit) 201, a forwarding-destination-port decision unit (forwarding-destination decision unit) 202, an FDB-flush determination unit 203, an address-learning processing unit 204, an FDB management unit 205, and an address-search processing unit 206.

At the time of reception, the PHY unit 11 performs PHY (physical) layer processing of a reception signal, that is a communication medium signal arriving from the inter-ring connection link 5-1 (the inter-ring connection link 5-2 in the case of the node 1-2, 1-4) through the inter-ring connection port 21, to extract frame data and forwards the extracted data to a block at the subsequent stage (a reception processing unit of the inter-ring connection-port I/F unit 12) in the form of a frame. At the time of transmission, the PHY unit 11 converts frame data having received from a block at the previous stage (a transmission processing unit of the inter-ring connection-port I/F unit 12) into a communication medium signal through PHY layer processing to generate a transmission signal to the inter-ring connection port.

The inter-ring connection-port I/F unit 12 is functionally divided into the reception processing unit and the transmission processing unit. The reception processing unit identifies an arrival frame, extracts information for searching an FDB (such as a destination address and data for identifying a flow) from the arrival frame, and notifies the L2 forwarding unit 20 of the extracted information. The reception processing unit selects a port (either the West ring port 22 or the East ring port 23) to which the frame is to be transmitted, based on an FDB search result provided from the L2 forwarding unit 20, and forwards the frame to a position connected to the relevant port of a block at the subsequent stage (ring-port output-processing unit 13) when there is no BP setting instruction from the inter-ring connection-failure management unit 18. At that time, the frame is forwarded to the selected one of the ports as a unicast when a transmission destination is already learned, whereas the frame is forwarded to both of the ports in the case of Flooding. When a result of the arrived frame identification indicates that the frame is a control frame for inter-ring connection failure management, the reception processing unit forwards arrival notification and internal information of the frame to the inter-ring connection-failure management unit 18 and further notifies the L2 forwarding unit 20 of information for leaning the FDB (such as a transmission source address and data for identifying a flow). The reception processing unit confirms validity of the received frame and discards the received frame when the frame is not valid (it has an error).

The transmission processing unit of the inter-ring connection-port I/F unit 12 generates a control frame for inter-ring connection failure management, outputs the generated frame to the PHY unit 11, and outputs a frame from the block at the previous stage (frame from an inter-ring connection-port output-processing unit of the frame multiplex-control unit 13) to the PHY unit 11.

The frame multiplex-control unit 13 is divided into the ring-port output-processing unit and the inter-ring connection-port output-processing unit corresponding for each of the West ring port 22 and the East ring port 23. The ring-port output-processing unit performs a two-input/one-output transmission arbitration for multiplexing a frame in an Add traffic that is inputted from the inter-ring connection-port I/F unit 12 and a frame in a Transit traffic that is forwarded from the West I/F unit 14 or the East-port I/F unit 15 (the I/F unit of each ring port) and outputting the multiplexed result to a ring.

The inter-ring connection-port output-processing unit of the frame multiplex-control unit 13 performs a two-input/one-output transmission arbitration for multiplexing a frame in a Drop traffic forwarded from the West I/F unit 14 or the East-port I/F unit 15 and outputting the multiplexed result to the inter-ring connection port 21.

The West-port I/F unit 14 is functionally divided into a reception processing unit and a transmission processing unit. The reception processing unit identifies an arrival frame, extracts information for searching the FDB (such as a destination address and data for identifying a flow) from the arrived frame, and notifies the L2 forwarding unit 20 of the extracted information. The reception processing unit of the West-port I/F unit 14 selects a port (the inter-ring connection port 21 or the East ring port 23) to which a received frame is to be transmitted based on an FDB search result provided from the L2 forwarding unit 20.

The reception processing unit of the West-port I/F unit 14 forwards the frame to a position connected to a relevant port of a block at the subsequent stage (the frame multiplex-control unit 13) when there is no BP setting instruction from the ring-failure management unit 19. For this, the frame is forwarded to the selected one of the ports as a unicast when a destination is already learned, whereas the frame is forwarded to both of the ports in the case of Flooding. When a result of the arrival frame identification indicates that the frame is a control frame for ring failure management, the reception processing unit of the West-port I/F unit 14 also forwards arrival notification and internal information of the frame to the ring-failure management unit 19, and notifies the L2 forwarding unit 20 of information for learning the FDB (such as a transmission source address and data for identifying a flow). The reception processing unit confirms validity of the received frame and discards the received frame when the frame is not valid (it has an error).

The transmission processing unit of the West-port I/F unit 14 generates a control frame for inter-ring connection failure management and outputs the generated frame to the PHY unit 11 by way of the frame multiplex-control unit 13 and the inter-ring connection-port I/F unit 12. The transmission processing unit outputs a frame from a block at the previous stage (the ring-port output-processing unit of the frame multiplex-control unit 13) to the PHY unit 16, thereby forwarding the frame to the West ring port 22.

The East-port I/F unit 15 is functionally divided into a reception processing unit and a transmission processing unit. The reception processing unit performs identification of an arrival frame, extracts information for searching the FDB (such as a destination address and data for identifying a flow) from the arrival frame, and notifies the L2 forwarding unit 20 of the extracted information. The reception processing unit of the East-port I/F unit 15 selects a port (the inter-ring connection port 21 or the West ring port 22) to which the received frame is to be transmitted, based on an FDB search result provided from the L2 forwarding unit 20.

The reception processing unit of the East-port I/F unit 15 forwards the frame to a position connected to a relevant port of a block at the subsequent block (the frame multiplex-control unit 13) when there is no BP setting instruction from the ring-failure management unit 19. For this, the frame is forwarded to the selected one of the ports as a unicast when a destination is already learned, whereas the frame is forwarded to both of the ports in the case of Flooding. When a result of the arrival frame identification indicates that the frame is a control frame for ring failure management, the reception processing unit of the East-port I/F unit 15 forwards arrival notification and internal information of the frame to the ring-failure management unit 19, and notifies the L2 forwarding unit 20 of information for learning the FDB (such as a transmission source address and data for identifying a flow). The reception processing unit confirms validity of the received frame and discards the received frame when the frame is not valid (it has an error).

The transmission processing unit of the East-port I/F unit 15 generates a control frame for inter-ring connection failure management, and outputs the generated frame to the PHY unit 11 by way of the frame multiplex-control unit 13 and the inter-ring connection-port I/F unit 12. The transmission processing unit also outputs a frame from a block at the previous stage (the ring-port output-processing unit of the frame multiplex-control unit 13) to the PHY unit 17, thereby forwarding the frame to the East ring port 23.

The PHY unit 16 performs PHY layer processing of a reception signal that is a communication medium signal arriving from the inter-ring connection link 5-1, to extract frame data therefrom, and forwards the extracted data to a block at the subsequent stage (the reception processing unit of the West-port I/F unit 14) in the form of a frame. The PHY unit 16 also performs PHY layer processing whereby frame data outputted from a block at the previous stage (the transmission processing unit of the West-port I/F unit 14) are converted into a communication medium signal, and sends out the signal from the West ring port 22.

The PHY unit 17 performs PHY layer processing of a reception signal that is a communication medium signal arriving from the inter-ring connection link 5-1, to extract frame data therefrom, and forwards the extracted data to a block at the subsequent block (the reception processing unit of the East-port I/F unit 15) in the form of a frame. The PHY unit 17 also performs PHY layer processing whereby frame data outputted from a block at the previous stage (the transmission processing unit of the East-port I/F unit 15) are converted into a communication medium signal, and sends out the signal from the East ring port 23.

The inter-ring connection-failure management unit 18 checks normality of the inter-ring connection link 5-1, that is a communication path connected between its own node and the opposed inter-ring connection node. The inter-ring connection-failure management unit 18 holds therein information of a flow forwarding rule obtained from the inter-ring connection node (the node 1-3) of an adjacent ring (the ring 3-2) connected therewith via the inter-ring connection link 5-1, compares the obtained flow forwarding rule with information held therein, and notifies the L2 forwarding unit 20 of a comparison result. The inter-ring connection-failure management unit 18 also performs failure detection and, when a failure is detected, performs BP setting control and notifies the L2 forwarding unit 20 of change in the flow forwarding rule at the time of failure occurrence.

The ring-failure management unit 19 checks normality of a communication path on a ring network (the ring 3-1) to detect a failure in the ring network. The ring-failure management unit 19 also performs ERP control similar to the conventional technique, such as BP setting control at the time of detection of a failure.

The L2 forwarding unit 20 determines whether to perform Flooding for the reception frame received from a ring port (the East ring port 22 or the West ring port 23) or the inter-ring connection port 21, searches the FDB (forwarding database) to determine a forwarding destination port of the reception frame, decides on the forwarding destination port, and notifies the I/F unit of each port (the inter-ring connection-port I/F unit 12, the West-port I/F unit 14, or the East-port I/F unit 15). The L2 forwarding unit 20 also performs learning of the FDB to register information about in which port destination the transmission source node is located. The L2 forwarding unit 20 also determines whether or not to perform FDB flush at a timing of communication path switching, based on the failure information and BP setting information provided from the failure management units (the inter-ring connection-failure management unit 18 and the ring-failure management unit 19), and performs the FDB flush when necessary.

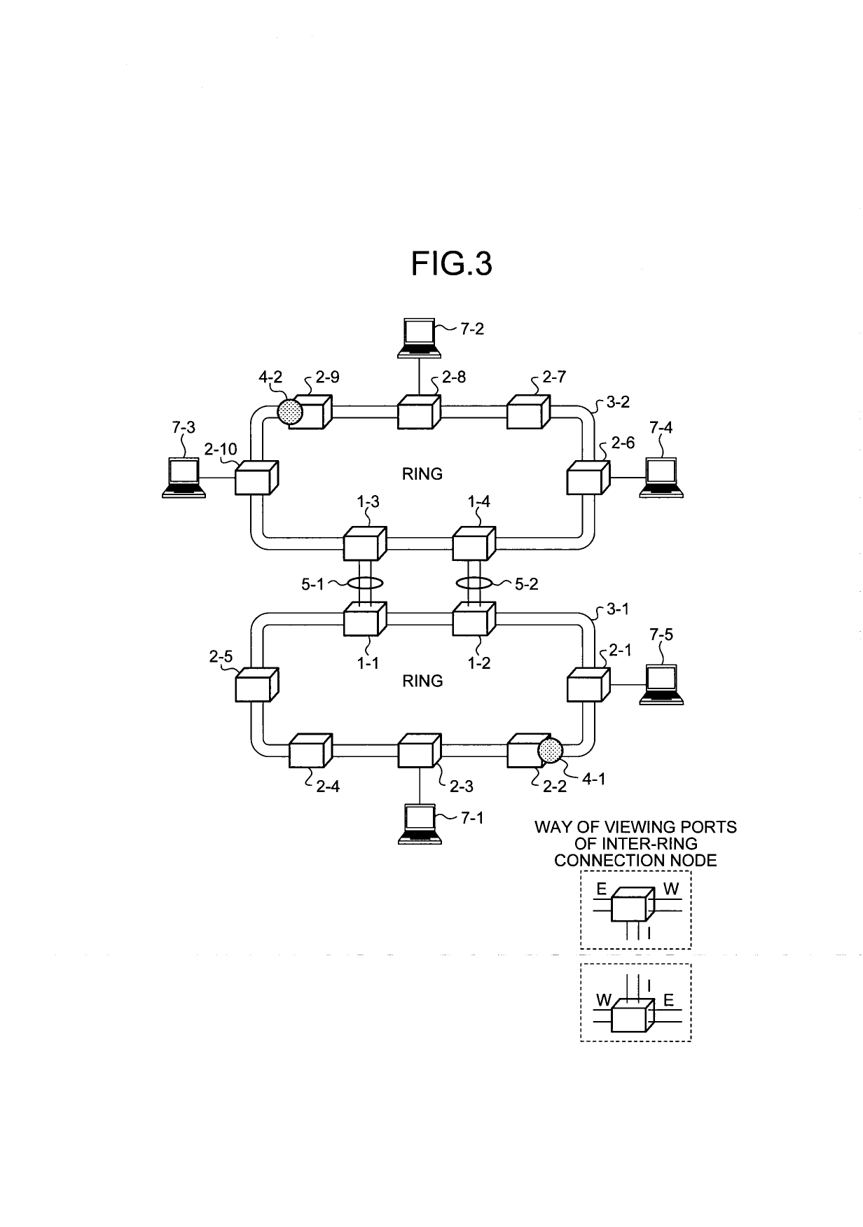

Operations in the present embodiment are explained next. FIG. 3 is a configuration example of a communication system to which terminals 7-1 to 7-5 are connected. FIG. 3 depicts an example in which the terminals 7-1 to 7-5 are connected to the communication system shown in FIG. 1. As shown in FIG. 3, the terminal 7-1 is connected to the node 2-3, the terminal 7-2 is connected to the node 2-8, the terminal 7-3 is connected to the node 2-10, the terminal 7-4 is connected to the node 2-6, and the terminal 7-5 is connected to the node 2-1.

The East ring port (E port) 23 of the node 1-1 or 1-2 as the inter-ring connection node is on the right side of the node, the West ring port (W port) 22 is on the left side thereof, and the inter-ring connection port (I port) 21 is on the upper side thereof in FIG. 3. The East ring port (E port) 23 of the node 1-3 or 1-4 is on the left side in FIG. 3, the West ring port (W port) 22 is on the right side, and the inter-ring connection port (I port) 21 is on the lower side.

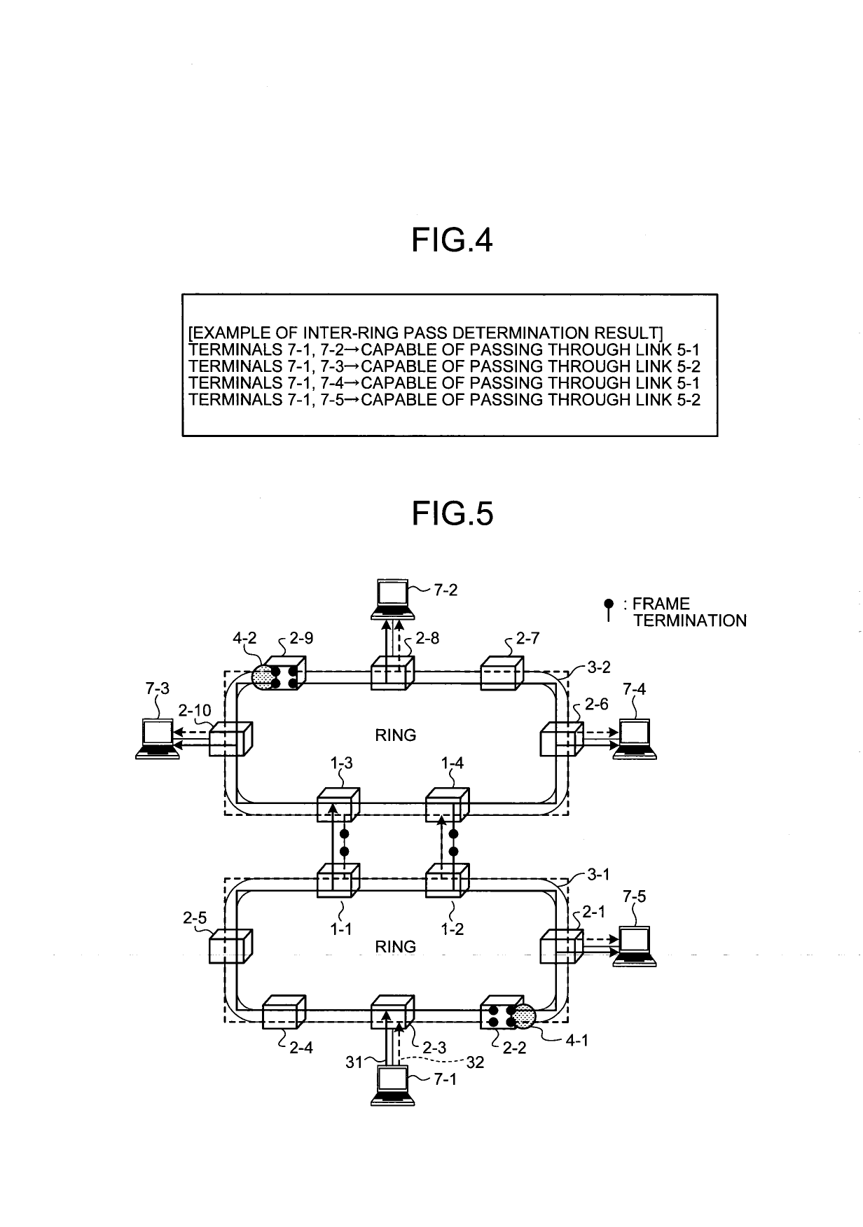

FIG. 4 is an example of an inter-ring pass determination result obtained using inter-ring pass determination rules according to the present embodiment. In the present embodiment, when a frame is to be forwarded to an adjacent ring, an inter-ring connection node exclusively classifies flows into two groups based on flow information for identifying the flows, and forwards flows belonging to the same group using the same inter-ring connection link. Accordingly, each flow is caused to pass through either the inter-ring connection link 5-1 or 5-2, thereby preventing occurrence of a loop frame and double arrival of a frame.

The inter-ring pass determination rules shown in FIG. 4 use a transmission source address and a destination address as the flow information, and a flow is identified by the transmission source address and the destination address. By virtue of predetermining which one of two groups the flows belong as rules based on the transmission source addresses and the destination addresses, the flows are classified into the two groups.

In the example shown in FIG. 4, flows transmitted or received between the terminals 7-1 and 7-2 can pass through the ring 5-1, flows transmitted or received between the terminals 7-1 and 7-3 can pass through the ring 5-2, flows transmitted or received between the terminals 7-1 and 7-4 can pass through the ring 5-1, and flows transmitted or received between the terminals 7-1 and 7-5 can pass through the ring 5-2.

In this way, to exclusively assign flows to the inter-ring connection links, an inter-ring pass determination rules for enabling the flow to as through the link is defined beforehand for each inter-ring connection link. An inter-ring connection link through which the flow can pass is then decided for each flow based on determination (an inter-ring pass determination) of which inter-ring pass determination rule the flow information matches.

A method of classifying flows into the two groups, that is, an inter-ring pass determination method (a method of comparing the flow information with the inter-ring pass determination rules) can be any method, but for example, an XOR (eXclusive OR) of all bits constituting both of the transmission source address and the destination address may be calculated and the determination may be performed using a Boolean form having a value of 0 or 1. It may be a method in which the inter-ring pass determination rules take the Boolean form and it is determined whether or not a flow can pass through to an inter-ring connection port based on values of the flow information and the inter-ring pass determination rule.

As the inter-ring pass determination rules, the same rules are previously set for the nodes 1-1 to 1-4 that are the inter-ring connection nodes. The inter-ring pass determination rules can be changed, and when any of the inter-ring connection nodes changes the inter-ring pass determination rules, the changed inter-ring pass determination rules are provided to the other inter-ring connection nodes, and the other inter-ring pass determination rules also reflect the changes.

Items of the flow information to be used for identifying flows, the method of setting the inter-ring pass determination rules, and the method of comparing the flow information with the inter-ring pass determination rules are not limited to those mentioned above. For example, information different from the transmission source address and the destination address can be added as the flow information to be used for identifying flows. The method needs not to assign each flow to an inter-ring connection link through which the flow passes, and any assignment method can be used as long as it permits a flow to exclusively pass through any of the inter-ring connection links for each frame, such as a method of assigning links in units of frames.

A Flooding operation in the present embodiment when the FDB is not learned yet is explained next. FIG. 5 is an example of Flooding flows in the communication system shown in FIG. 3. FIG. 5 depicts an example to which the inter-ring pass determination rules having the inter-ring pass determination results shown in FIG. 4 as presupposed elements are applied, and in which it is determined that a flow 31 (flow shown by solid arrows in FIG. 5) having the terminal 7-1 as a transmission source and the terminal 7-2 as a destination can pass through the link 5-1 and that a flow 32 (flow shown by dotted arrows in FIG. 5) having the terminal 7-1 as a transmission source and the terminal 7-3 as a destination can pass through the link 5-2. In FIG. 5, all nodes 1-1 to 1-4 and 2-1 to 2-10 have not performed FDB learning of the destination nodes of the flows 31 and 32 yet.

First, from the terminal 7-1 in the ring 3-1, the flows 31 and 32 (a frame addressed to the terminal 7-2 and a frame addressed to the terminal 7-3) are transmitted from both ring ports (the West ring port 22 and the East ring port 23). Upon reception of the flows 31 and 32, the nodes 2-1 to 2-5 in the ring 3-1 performs Flooding transmission to ring ports other than a reception port because the nodes have not learned the destination yet. However, the node 2-2 to which a BP is set does not perform transmission to a port to which the BP is set.

Upon reception of the flows 31 and 32, the node 1-1 as the inter-ring connection node conventionally performs Flooding transmission to ports (the inter-ring connection port 21 and the East ring port 23) other than a reception port (the West ring port 22) because it has not performed address learning yet. However, in the present embodiment, the node 1-1 performs inter-ring pass determination based on the flow information and the inter-ring pass determination rules. Then, as a result of the inter-ring pass determination, the node 1-1 performs Flooding transmission of the flow 31 to the East ring port 23 and the inter-ring connection port 21 and performs Flooding transmission of the flow 32 only to the East ring port 23 because the flow 32 can pass through the link 5-2 (because the flow 32 can not pass through the link 5-1).

On the other hand, upon reception of the flows 31 and 32, the node 1-2 as the other inter-ring connection node in the ring 3-1 performs the inter-ring pass determination, and performs Flooding transmission of the flow 31 only to the East ring port 23 and Flooding transmission of the flow 32 to the East ring port 23 and the inter-ring connection port 21, contrary to the node 1-2.

In this way, by setting the inter-ring pass determination rules, one and the same flow can not pass through plural inter-ring connection links. The flows 31 and 32 forwarded to an adjacent ring (the ring 3-2) through the inter-ring connection links 5-1 and 5-2 are subjected to Flooding transmission to both ring ports because destination learning has not been performed yet in the inter-ring connection nodes 1-3 and 1-4.

The flow 31 subjected to Flooding transmission by the node 1-3 is forwarded in the ring 3-2 and arrives at the node 1-4. Because it is determined from the inter-ring pass determination that the flow 31 can pass through the link 5-1 (but can not pass through the link 5-2), the flow 31 is not forwarded to the inter-ring connection port 21 and is Flooding-transmitted to a ring port opposite to a reception port. Similarly, the flow 32 subjected to Flooding transmission by the node 1-4 is forwarded in the ring 3-2 and arrives at the node 1-3. Because it is determined from the inter-ring pass determination that the flow 32 can pass through the link 5-2 (but can not pass through the link 5-1), the flow 32 is not forwarded to the inter-ring connection port 21 and is Flooding-transmitted to a ring port opposite to a reception port. In this way, a reverse flow to the ring 3-1 being a forwarding source is avoided. Therefore, occurrence of a loop frame and double arrival of a frame due to the Flooding operation of the inter-ring connection nodes can be avoided.

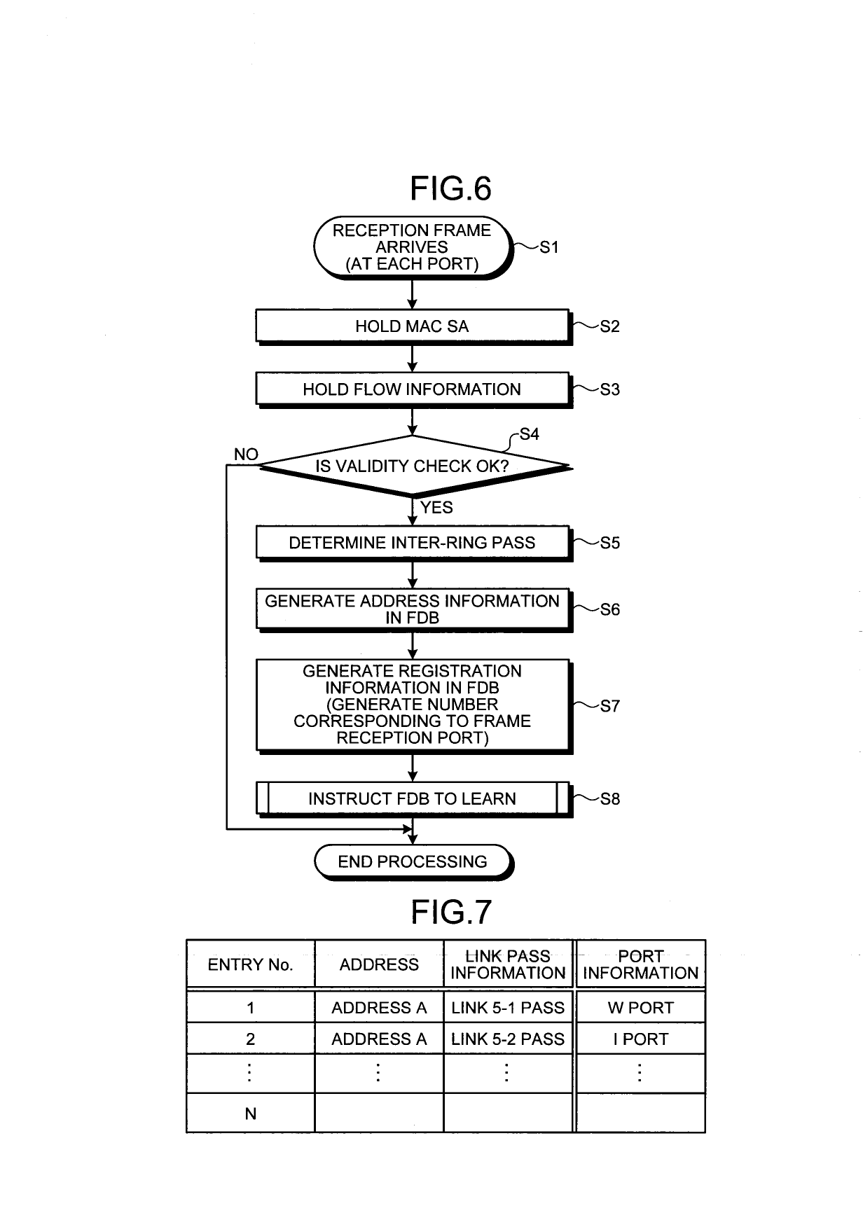

FDB learning in the nodes 1-1 to 1-4 as the inter-ring connection nodes in the present embodiment is explained next. FDB learning in the nodes 2-1 to 2-10 is the same as that in the conventional technique. FIG. 6 is a flowchart of an example of an FDB learning procedure in the inter-ring connection node according to the present embodiment.

First, when an unlearned reception frame (a combination of a transmission source address and a reception port of which is not registered in the FDB) arrives (is received) (Step S1), a port I/F unit (one of the West-port I/F unit 14, the East-port I/F unit 15, and the inter-ring connection-port I/F unit 12) corresponding to a port that has received the frame extracts a transmission source address (MAC SA) of the reception frame and holds the address (Step S2), and extracts the flow information (the transmission source address and a destination address in this example) and holds the information (Step S3).

The port I/F unit then confirms validity of the reception frame by a frame check sequence (FCS) check or the like (Step S4), and when the frame is not valid (NO at Step S4), discards the frame and ends the processing.

When the frame is valid (YES at Step S4), the port I/F unit notifies the flow-information-pass determination unit 201 in the L2 forwarding unit 20 of the flow information, and the flow-information-pass determination unit 201 performs the inter-ring pass determination based on the inter-ring pass determination rules held therein and the flow information (Step S5).

The flow-information-pass determination unit 201 notifies the address-learning processing unit 204 of a result of the inter-ring pass determination (information of which inter-ring connection link the frame can pass through) and the flow information. The address-learning processing unit 204 receives identification information of a port (a reception port) having received the reception frame from the port I/F unit corresponding to the reception port. Then, the address-learning processing unit 204 generates a corresponding entry having the transmission source address and the inter-ring pass determination result (link pass information) out of the provided flow information as address information to the FDB stored in the FDB management unit 205 (Step S6). The address information is used to search the FDB, and the transmission source address and the link pass information are used as the address information in the present embodiment. A number indicating the reception port is generated as a port number corresponding to the relevant entry in the FDB (Step S7). This port number can be any number as long as it can identify each of the ports (the inter-link connection port 21, the West ring port 22, and the East ring port 23).

The address-learning processing unit 204 then instructs the FDB of the FDB management unit 205 to learn the generated port number as port information corresponding to the entry generated at Step S6 (registers the port number in the FDB) (Step S8), and ends the processing.

FIG. 7 is an example of an FDB configuration according to the present embodiment. The address (the transmission source address of a reception frame), the pass link information (the inter-ring pass determination result), and the port information are stored in association with each other for each entry. While FIG. 7 has descriptions of the link identification information of the link 5-1 or the like and port identification information of the W port or the like as the pass link information and the port information for easy understanding, simplified numbers or the like are practically registered (for example, a number “0” is assigned to the link 5-1, a number “1” is assigned to the link 5-2, and as port numbers, the inter-link connection port 21, the West ring port 22, and the East ring port 23 are assigned with “1”, “2”, and “3”, respectively). The port numbers and the like generated at Step S7 are registered. In the present embodiment, when the FDB is to be searched, the port information of a forwarding destination is acquired using the address and the pass link information as search keys.

While one port corresponds to one address in the conventional FDB, two entries having different inter-ring links through which a flow passes can be registered for one address A in the present embodiment as shown in FIG. 7. Accordingly, two ports can be registered as forwarding destinations even for one and the same address, and ports corresponding to two groups having the inter-ring connection links 5-1 and 5-2 through which a flow passes, respectively, due to different destinations even under one and the same transmission source can be registered.

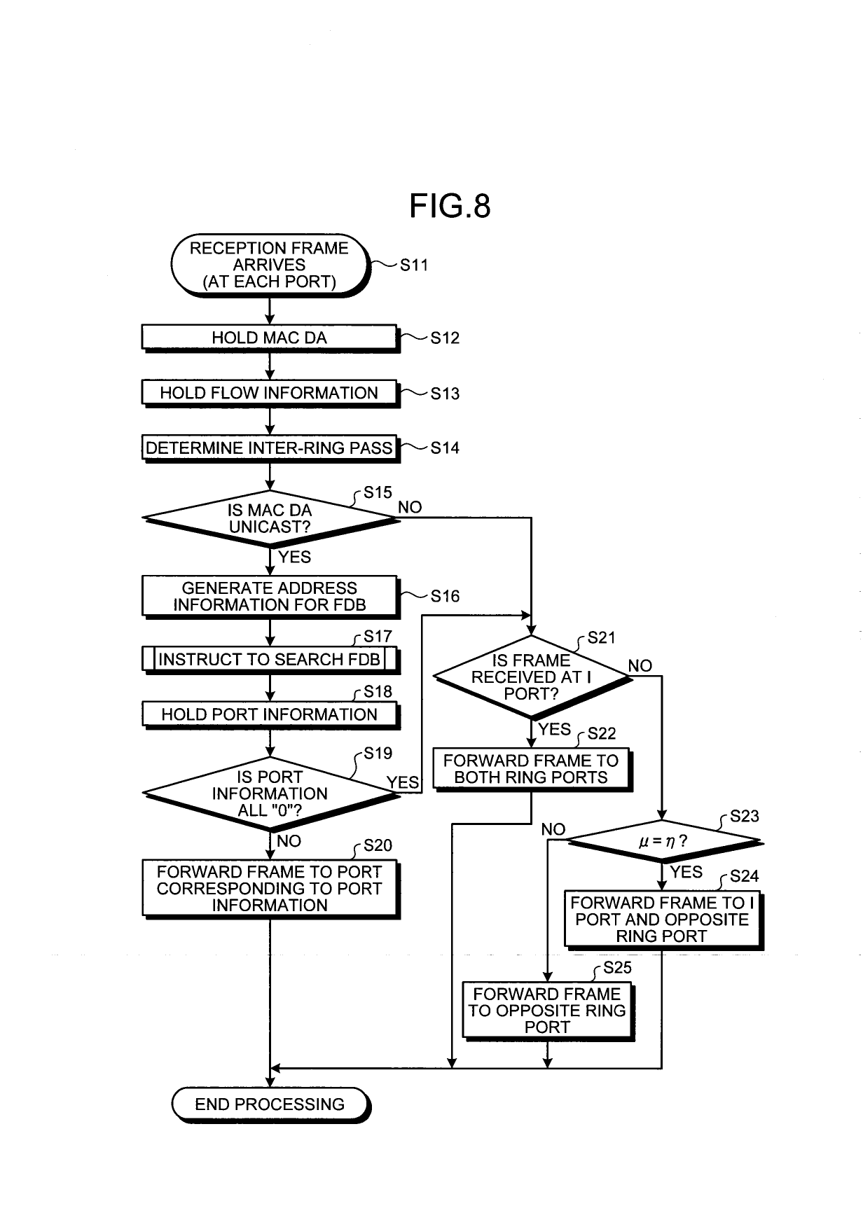

FIG. 8 is a flowchart of an example of an L2 forwarding procedure in the inter-ring connection node in the present embodiment. When a reception frame arrives (is received) (Step S11), a port I/F unit (one of the West-port I/F unit 14, the East-port I/F unit 15, and the inter-ring connection-port I/F unit 12) corresponding to a port having received the frame extracts a destination address (MAC DA) of the reception frame and holds the address (Step S12), and extracts the flow information (the transmission source address and the destination address in this example) and holds the extracted information (Step S13).

The port I/F unit notifies the flow-information-pass determination unit 201 in the L2 forwarding unit 20 of the flow information, and the flow-information-pass determination unit 201 performs the inter-ring pass determination based on the inter-ring pass determination rules held therein and the flow information (Step S14). The validity check of the frame may be performed before Step S14 as in FIG. 6.

The flow-information-pass determination unit 201 notifies the forwarding-destination-port decision unit 202 of a result of the inter-ring pass determination (information of which inter-ring connection link the flow can pass through) and the destination address, and the forwarding-destination-port decision unit 202 determines whether or not the destination address (MAC DA) is a unicast address (Step S15). When it is determined that the destination address is unicast (YES at Step S15), the forwarding-destination-port decision unit 202 generates address information for searching the FDB (Step S16), notifies the address-search processing unit 206 of the generated address information, and instructs the address-search processing unit 206 to search for port information corresponding to the generated address information (Step S17).

The address-search processing unit 206 searches the FDB to retrieve the port information corresponding to the provided address information and notifies the forwarding-destination-port decision unit 202 of the port information, and the forwarding-destination-port decision unit 202 holds the provided port information (Step S18). The forwarding-destination-port decision unit 202 determines whether or not the provided port information has a value indicating that the port information is not registered in the FDB (for example, a value of all “0”) (Step S19).

When the port information is registered (NO at Step S19), the forwarding-destination-port decision unit 202 decides a port corresponding to the provided port information as a forwarding destination, instructs a port I/F unit corresponding to the decided port to forward the reception frame to the decided port (Step S20), and ends the processing.

When it is determined at Step S15 that the destination address is not unicast (NO at Step S15), the forwarding-destination-port decision unit 202 determines whether or not the reception frame has been received at the inter-ring connection port 21 (Step S21). When the frame has been received at the inter-ring connection port 21 (YES at Step S21), the forwarding-destination-port decision unit 202 instructs port I/F units corresponding to the both ring ports to forward the reception frame to the both ring ports, respectively (Step S22), and ends the processing.

When the frame has not received at the inter-ring connection port 21 (NO at Step S21), the forwarding-destination-port decision unit 202 determines whether or not μ matches identification information (η) indicating an inter-ring connection link to which its own node is connected, where μ represents identification information of an inter-ring connection link through which the flow is determined to be able to pass based on the inter-ring pass determination result provided from the flow-information-pass determination unit 201 (Step S23). When μ matches η (YES at Step S23), the forwarding-destination-port decision unit 202 instructs the corresponding port I/F units to forward the reception frame to the inter-ring connection port 21 and a ring port opposite to the reception port, respectively (Step S24), and ends the processing. The present embodiment is on the assumption that the inter-ring connection nodes (the nodes 1-1 to 1-4) know identification information indicating the inter-ring connection link to which the nodes themselves are connected and identification information indicating the other inter-ring connection link, with being previously set therein, for example.

When μ does not match η (NO at Step S23), the forwarding-destination-port decision unit 202 instructs the corresponding port I/F units to forward the reception frame to the reception port and the ring port opposite to the reception port (Step S25), and ends the processing.

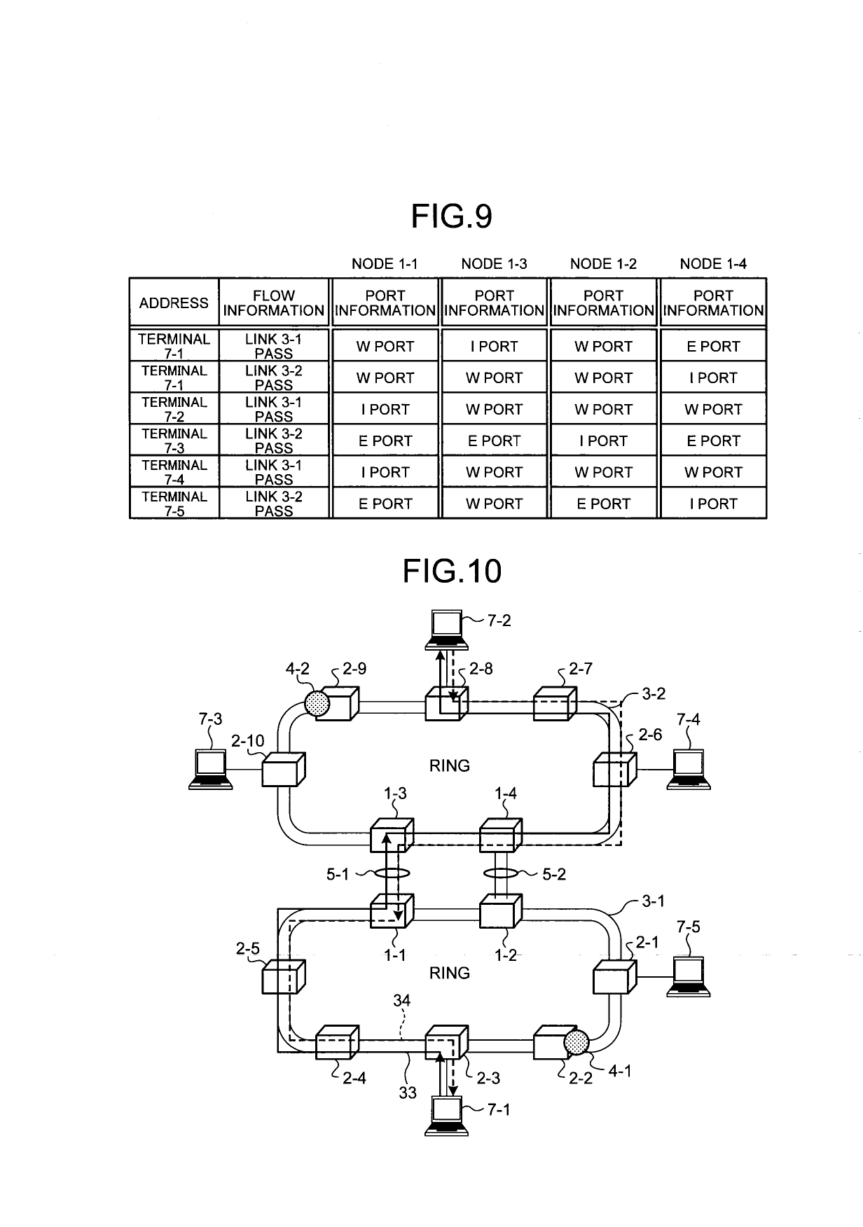

A flow of each communication in the communication system is explained next with reference to the drawings. FIG. 9 is an example of an FDB learning state of the nodes 1-1 to 1-4 according to the present embodiment. In FIG. 9, the port information with respect to each address and each piece of ring information is extracted from the FDB of each node and shown as a list. Terminal identification information is described as a terminal 7-1 in an address column in FIG. 9, but the address of the terminal 7-1 is registered in an actual FDB.

FIGS. 10 to 13 are examples of communication paths between terminals in the communication system according to the present embodiment. The communication paths shown in FIGS. 10 to 13 are premised on the FDB learning states shown in FIG. 9, and FIGS. 10, 10, 10 and 10 depict communication paths between the terminals 7-1 and 7-2, between the terminals 7-1 and 7-3, between the terminals 7-1 and 7-4, and between the terminals 7-1 and 7-5, respectively. In this embodiment, because the transmission source address and the destination address are used in the inter-ring pass determination, a flow passes through the same inter-ring connection link in outward and return paths.

FIG. 10 depicts an outward communication path 33 that is an outward path from the terminal 7-1 to the terminal 7-2 and a communication path 34 that is a return path. In the communication path 33, when a frame passes through the node 1-1, the frame is forwarded to the inter-ring connection port 21 according to an entry in the third row in FIG. 9 based on the inter-ring pass determination. Then, the node 1-3 having received the frame from the node 1-1 forwards the frame to the West ring port 22 based on the entry in the third row in FIG. 9. The frame is then forwarded in the ring 3-2 and arrives at the terminal 7-2.

In the communication path 34, when the node 1-4 receives the frame forwarded in the ring 3-2, the node 1-4 forwards the frame to the East ring port 23 according to an entry in the first row in FIG. 9 based on the destination address and the inter-ring pass determination result (pass through the link 5-1). The node 1-3 then forwards the frame to the inter-ring connection port 21 according to the entry in the first row in FIG. 9 based on the destination address and the inter-ring pass determination result (pass through the link 5-1). Then, the node 1-1 having received the frame from the node 1-3 forwards the frame to the West ring port 22 shown in the first row in FIG. 9 based on the destination address and the inter-ring pass determination result (pass through the link 5-1). The frame is then forwarded in the ring 3-1 and arrives at the terminal 7-1.

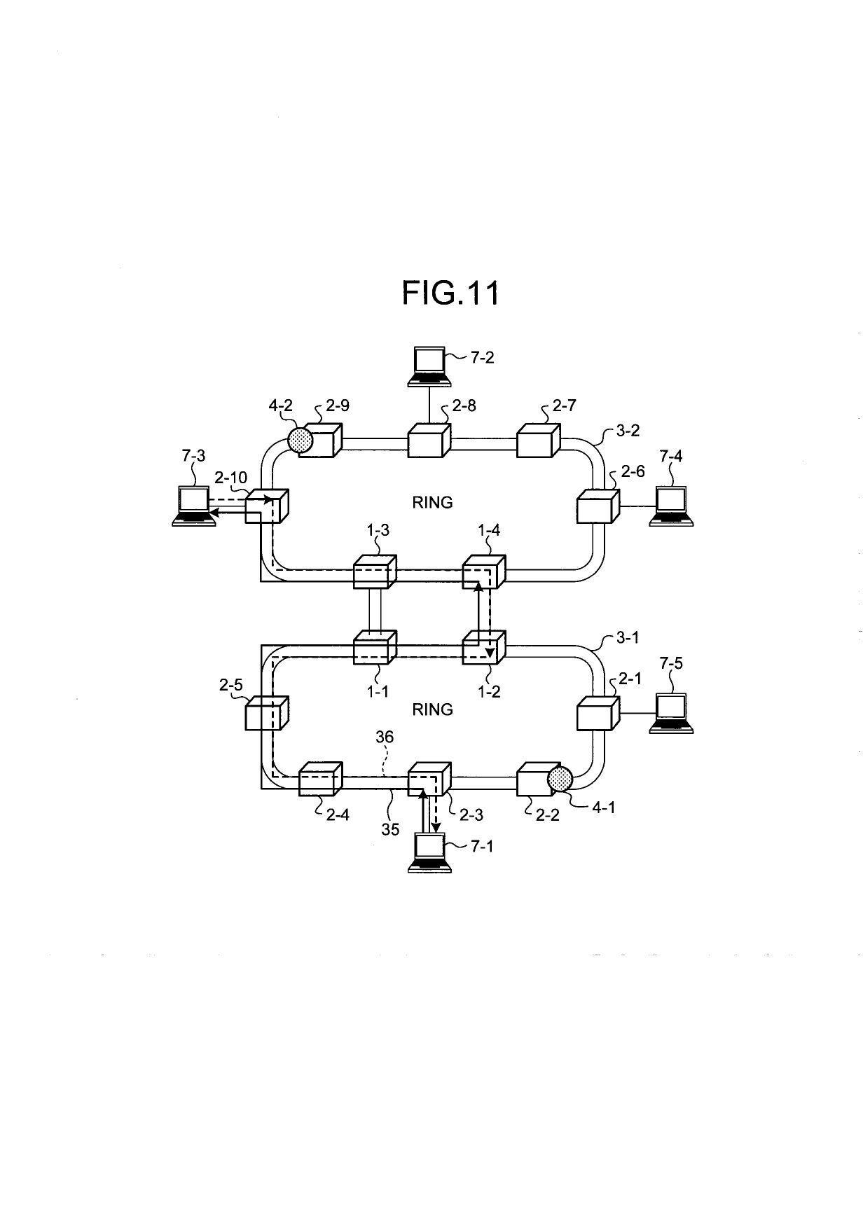

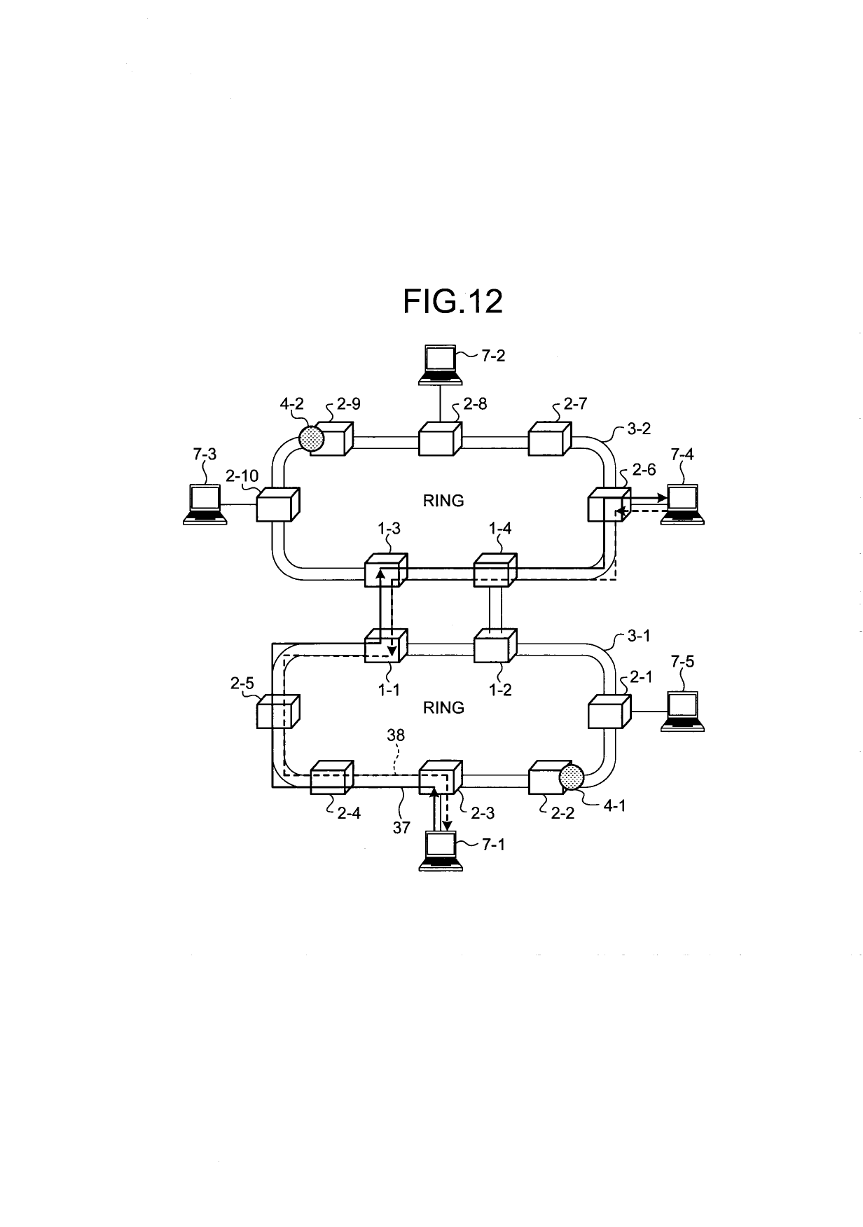

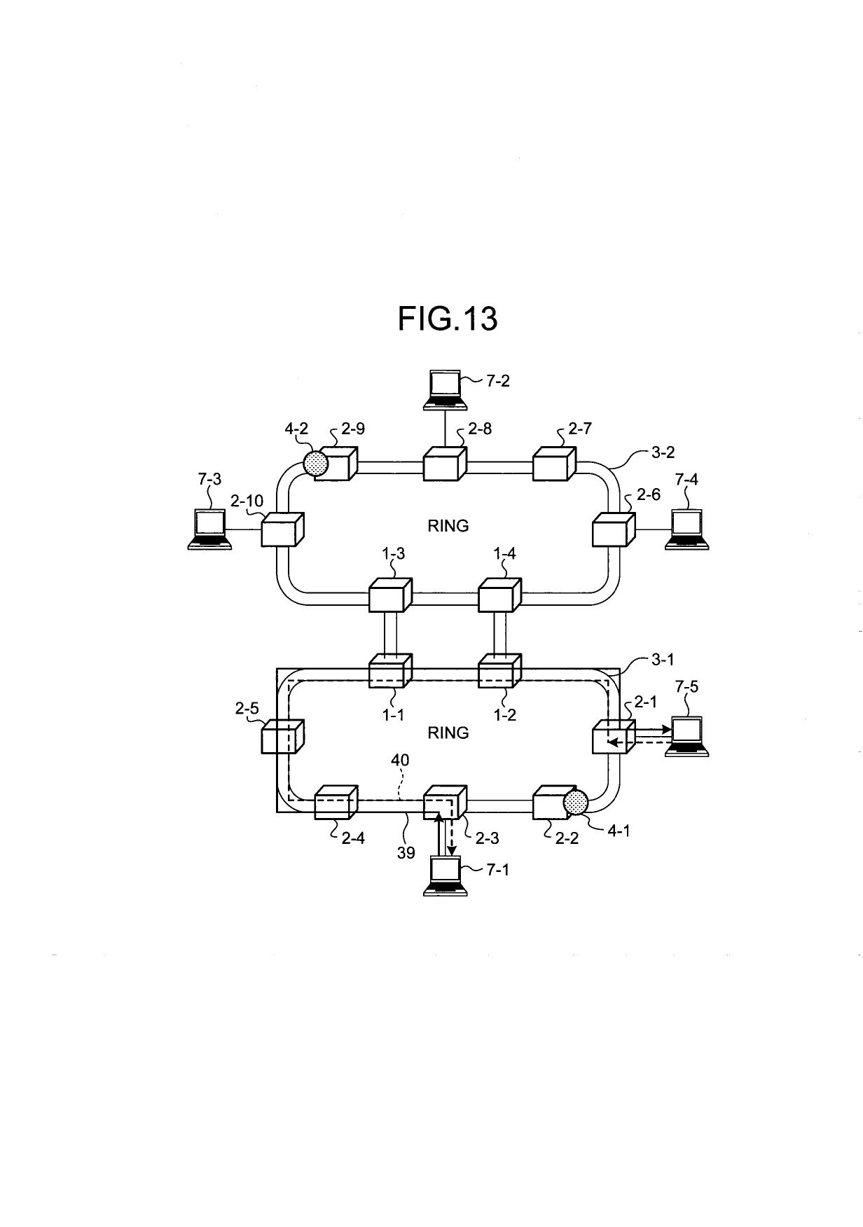

Similarly, an outward communication path 35 from the terminal 7-1 to the terminal 7-3 and a return communication path 36 thereof are shown in FIG. 11, an outward communication path 37 from the terminal 7-1 to the terminal 7-4 and a return communication path 38 thereof are shown in FIG. 12, and an outward communication path 39 from the terminal 7-1 to the terminal 7-5 and a return communication path 40 thereof are shown in FIG. 13.

Furthermore, the nodes 1-1 to 1-4 may provide information indicating the inter-ring pass determination rules attached to the control frame and exchange information with each other to check the sameness, thereby making it is possible that the nodes determine that the frame can be forwarded to the inter-ring connection link connected to the nodes themselves when it is determined as a result of the check that the inter-ring pass determination rules are the same, and that the frame is not forwarded when the inter-ring pass determination rules are different.

While the case where there are two inter-ring connection links has been explained in the present embodiment, the operation according to the present embodiment can be similarly applied to a case where there are N inter-ring connection links (N is an integer equal to or larger than 3) (there are 2N inter-ring connection nodes). In this case, the inter-ring pass determination rules are set as rules such that flows are assigned to N groups based on the flow information. When there are N inter-ring connection links, it is possible to use several links of the N inter-ring connection links at the same time without using all thereof at the same time and to assign the flows to the used several inter-ring connection links.

While flows in the case where the destination is a node in the adjacent link have been explained above as examples, similar flow assignment can be performed also in the case where a destination is not a node in the adjacent link but is a destination through the adjacent link (such as in another network that is not in the adjacent link and is located farther).

As described above, in the present embodiment, the nodes 1-1 to 1-4 as the inter-ring connection nodes set the rules for assigning flows to the two inter-ring connection links 5-1 and 5-2 based on the flow information as the inter-ring pass determination rules and, based on the flow information of a received frame and the inter-ring pass determination rules, determine an inter-ring connection link through which the relevant flow passes. Then, each of the nodes forwards a flow that is determined to pass through the inter-ring connection link to which the node itself is connected, to the adjacent link using the inter-ring connection link. Accordingly, when there are plural pairs of inter-ring connection nodes, band use efficiency can be enhanced and occurrence of a loop frame and double arrival of a frame can be avoided.

### Second Embodiment

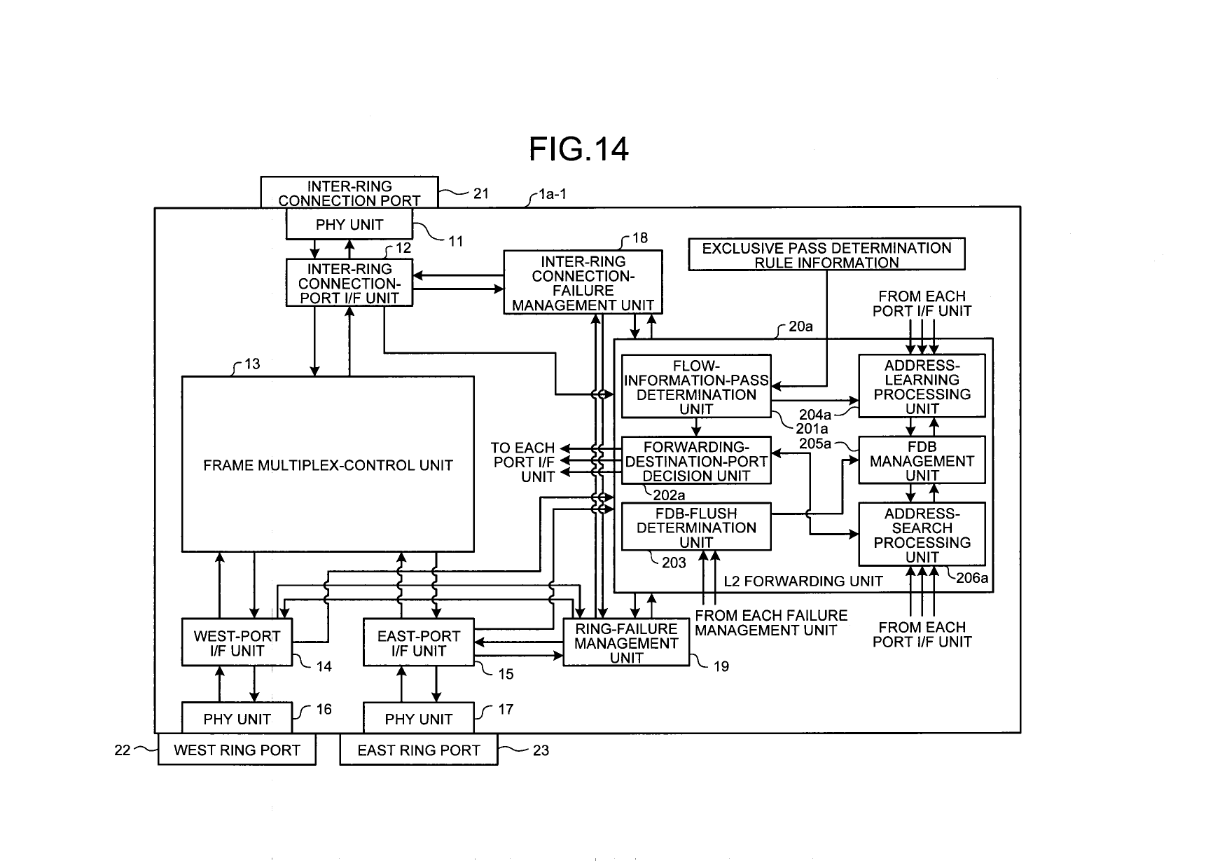

FIG. 14 is a functional configuration example of a node 1a-1 that is an inter-ring connection node according to a second embodiment of the present embodiment. The node 1a-1 of the present embodiment is equal to the node 1-1 of the first embodiment except that the L2 forwarding 20 of the node 1-1 of the first embodiment is replaced by an L2 forwarding 20a. A communication system according to the present embodiment is equal to the communication system according to the first embodiment except that the nodes 1-1 to 1-4 are replaced by nodes 1a-1 to 1a-4. Each of the nodes 1a-2 to 1a-4 has the same configuration as that of the node 1a-1. Constituent elements having functions identical to those of the first embodiment are denoted by like reference signs and redundant explanations thereof will be omitted.

The L2 forwarding 20a according to the present embodiment is equal to the L2 forwarding 20 according to the first embodiment except that the flow-information-pass determination unit 201, the forwarding-destination-port decision unit 202, the address-learning processing unit 204, the FDB management unit 205, and the address-search processing unit 206 are replaced by a flow-information-pass determination unit 201a, a forwarding-destination-port decision unit 202a, an address-learning processing unit 204a, an FDB management unit 205a, and an address-search processing unit 206a, respectively.

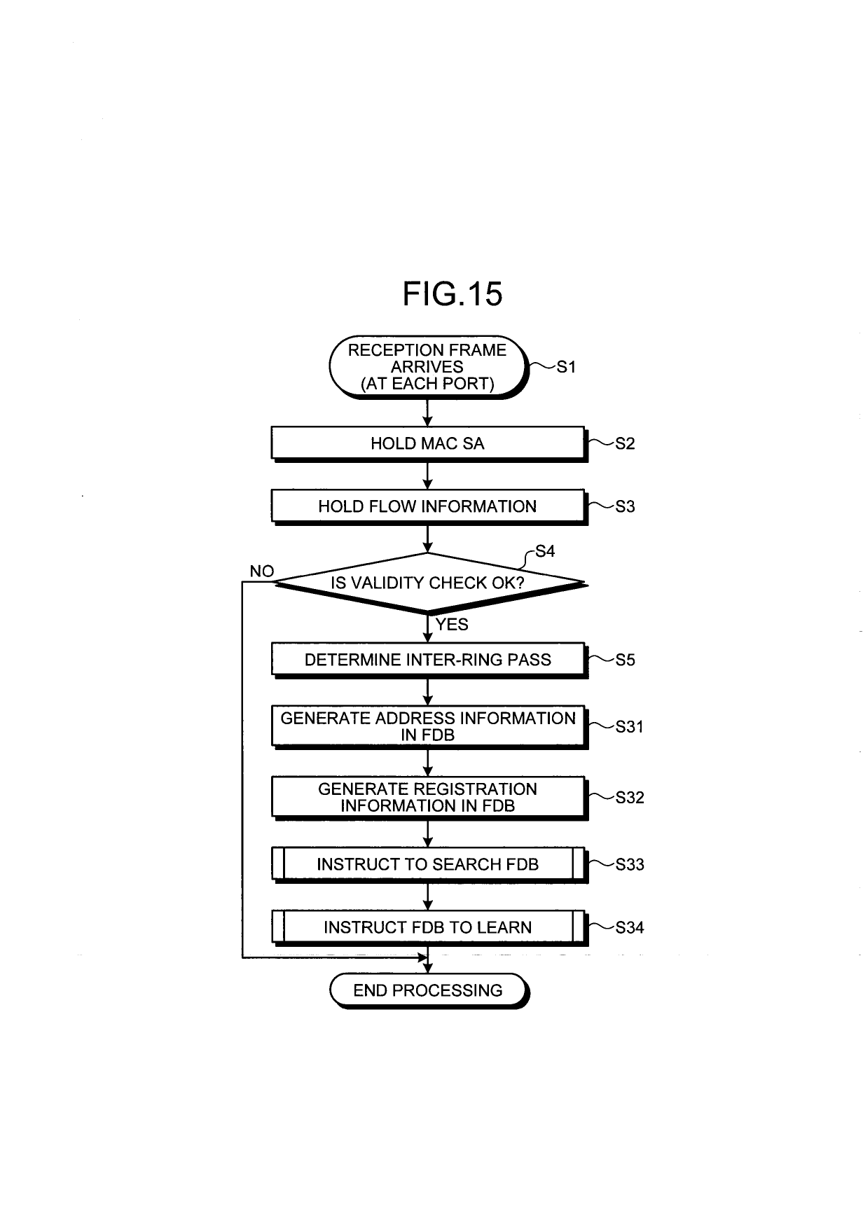

An FDB learning operation according to the present embodiment is explained next. FIG. 15 is a flowchart of an example of an FDB learning procedure in the inter-ring connection node according to the present embodiment. Steps S1 to S5 are the same as Steps S1 to S6 explained in the first embodiment. Herein, however, operations performed by the flow-information-pass determination unit 201 and the forwarding-destination-port decision unit 202 in the first embodiment are performed by the flow-information-pass determination unit 201a and the forwarding-destination-port decision unit 202a, respectively.

After Step S5, the flow-information-pass determination unit 201 notifies the address-learning processing unit 204a of the inter-ring pass determination result (information about which inter-ring connection link the flow can pass through) and the flow information. The address-learning processing unit 204a generates a corresponding entry having a transmission source address out of the provided flow information as address information to the FDB held in the FDB management unit 205 (Step S31). In the present embodiment, the FDB has a configuration in which three bits corresponding to three ports are prepared for each of the links 5-1 and 5-2 as the pass link information per address and a value of each bit means whether or not learning has been already performed (for example, an initial value (learning is not performed yet) is represented by “0” and a state in which learning has been performed is represented by “1”).

The address-learning processing unit 204a then receives identification information of a reception port from a port I/F unit corresponding to the reception port, and generates a port number indicating the reception port and identification information η indicating the inter-ring pass determination result (Step S32). The FDB held in the FDB management unit 205a is searched to retrieve pass link information of the entry corresponding to the transmission source address of the reception frame (Step S33), the pass link information is updated based on η and the port number to be registered in the FDB (Step S34), and then the processing is ended.

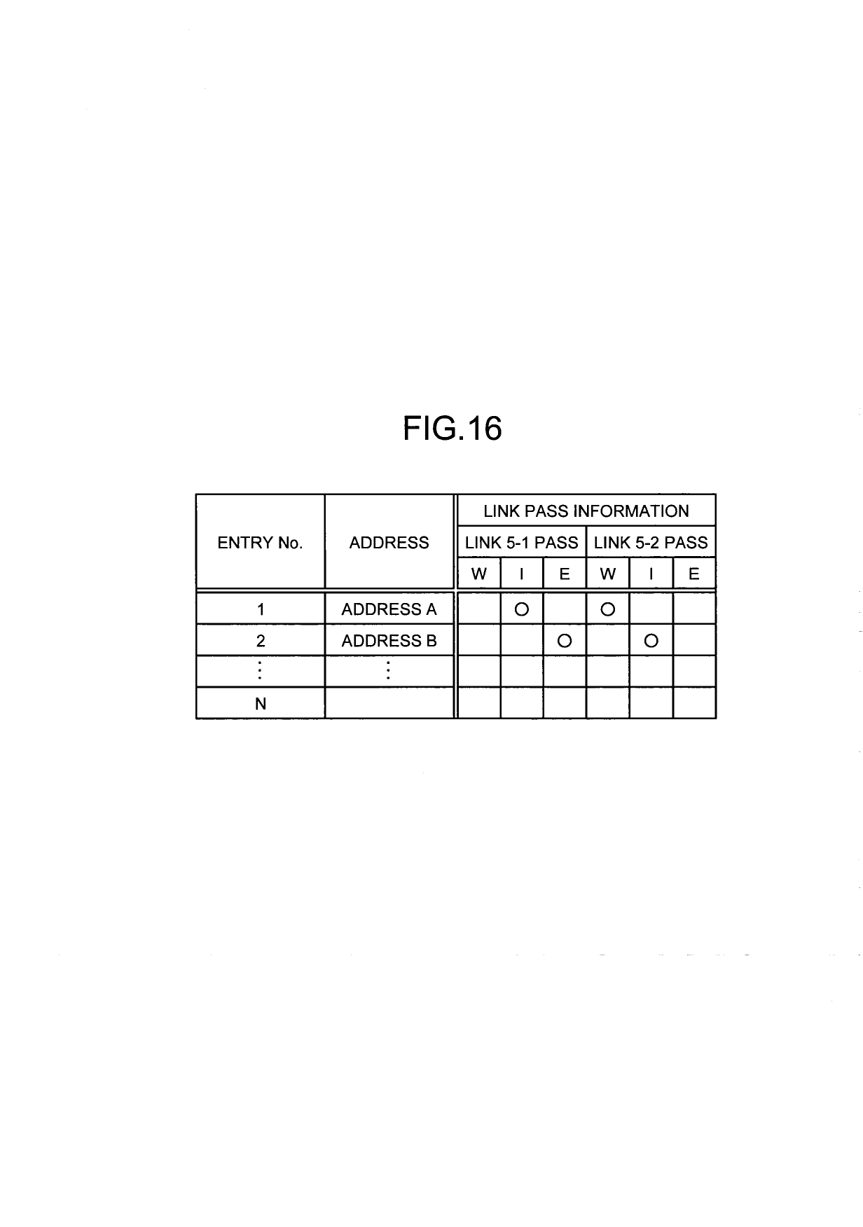

FIG. 16 is a configuration example of the FDB according to the present embodiment. As shown in FIG. 16, in each entry, a learned port (a reception port) is registered for each link through which the flow is determined to be able to pass with respect to an address. In FIG. 16, W denotes the West ring port 22, I denotes the inter-ring connection port 21, and E denotes the East ring port 23. Ports marked with white circles indicate learned ports and blanks indicate unlearned ports.

At the time of FDB search in the present embodiment, the same address (destination address) as in the conventional technique is used as a search key. The port information and the link pass information are then retrieved as a result of the search. With this FDB configuration, one address never has plural entries and thus a time required to delete each entry at the time of FDB flush becomes shorter than in the first embodiment.

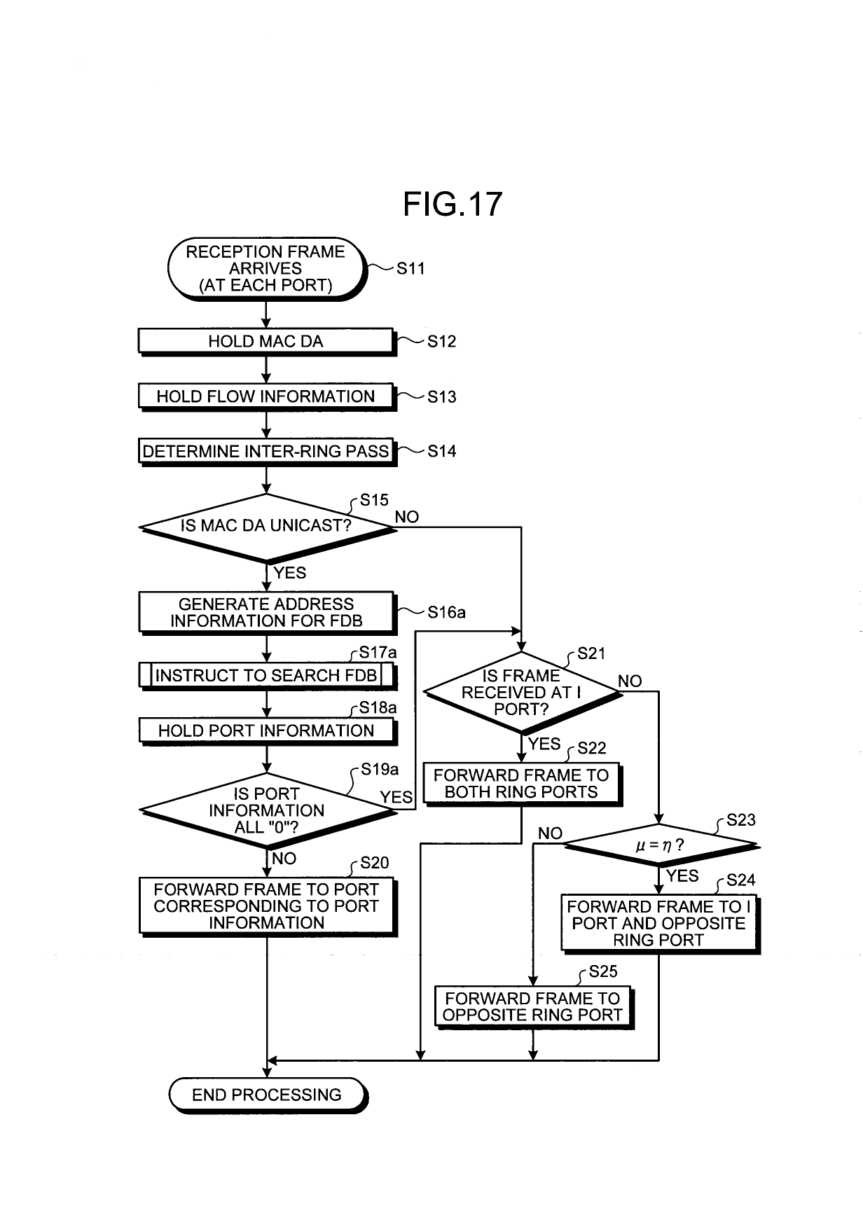

FIG. 17 is a flowchart of an example of an L2 forwarding procedure according to the present embodiment. Steps S11 to S15 are the same as Steps S11 to S15 according to the embodiment. Herein, however, the operations performed by the flow-information-pass determination unit 201 and the forwarding-destination-port decision unit 202 in the first embodiment are performed by the flow-information-pass determination unit 201a and the forwarding-destination-port decision unit 202a, respectively.

When the destination address is unicast at Step S15 (YES at Step S15), the forwarding-destination-port decision unit 202a generates address information as input information for searching the FDB (Step S16a), and notifies an address-search processing unit 206b of the address information together with the inter-ring pass determination result to instruct the address-search processing unit 206b to search the FDB (Step S17a). In the present embodiment, the address information is a destination address.

The address-search processing unit 206b searches the FDB held in the FDB management unit 205 by the address information (the destination address) and notifies the forwarding-destination-port decision unit 202a of retrieved information (link pass information/port information), and the forwarding-destination-port decision unit 202a holds the provided information (Step S18a). The forwarding-destination-port decision unit 202a determines whether or not the provided information is information indicating that there is no learned port (for example, bits corresponding to all ports of the link pass information of the both are “0” (Step S19a). When the provided information indicates that there is a learned port (NO at Step S19a), the same operation as that in the first embodiment is performed at Step S20.

When the provided information indicates that there is no learned port (YES at Step S19a), the same operation as that in the first embodiment is performed at Step S21. Subsequent steps of Steps S22 to S25 are identical to those of the first embodiment.

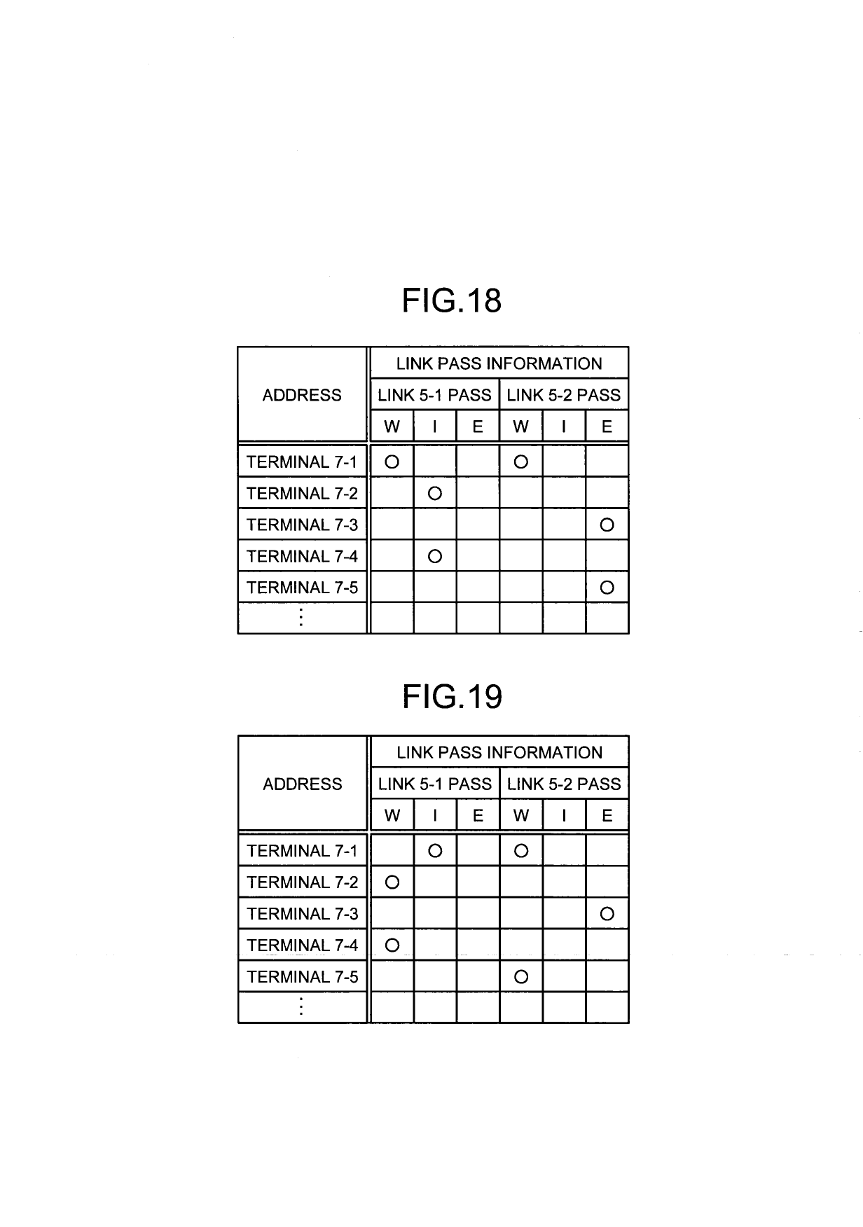

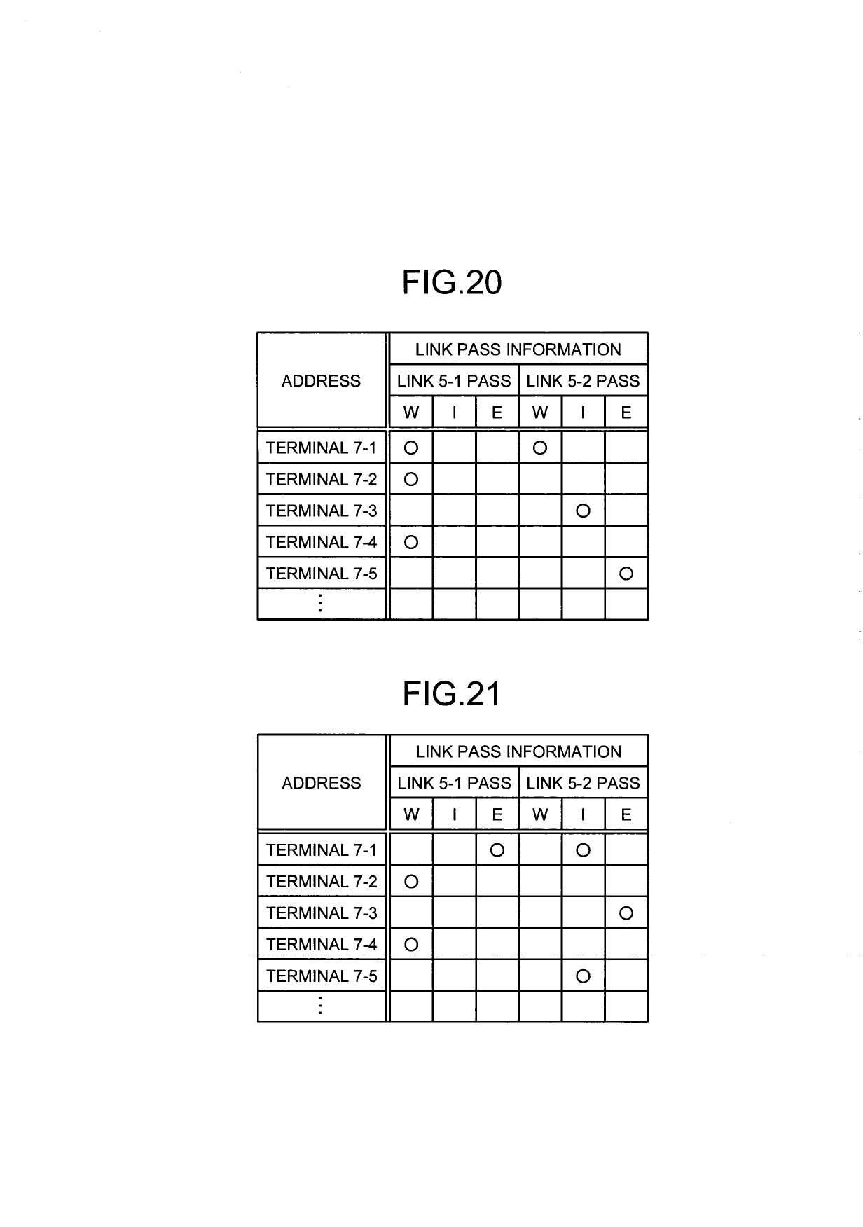

FIGS. 18 to 21 are examples of an FDB learning state according to the present embodiment. FIGS. 18 to 21 depict learning states equivalent to the state shown in FIG. 9 according to the first embodiment, in FDB configurations according to the present embodiment. FIG. 18 depicts the FDB held by the node 1-1, FIG. 19 depicts the FDB held by the node 1-2, FIG. 20 depicts the FDB held by the node 1-3, and FIG. 21 depicts the FDB held by the node 1-4. Operations of the present embodiment other than those described above are identical to corresponding ones of the first embodiment.

As described above, in the present embodiment, the FDB is configured to associate one entry with one address, and to store in each entry information indicating whether or not learning is already performed for each port with respect to each link through which the flow is determined to pass. Accordingly, the same effect as that in the first embodiment is achieved and also a time required to delete each entry at the time of FDB flush becomes shorter than in the first embodiment because one and the same address is not involved in the plural entries.

### Third Embodiment

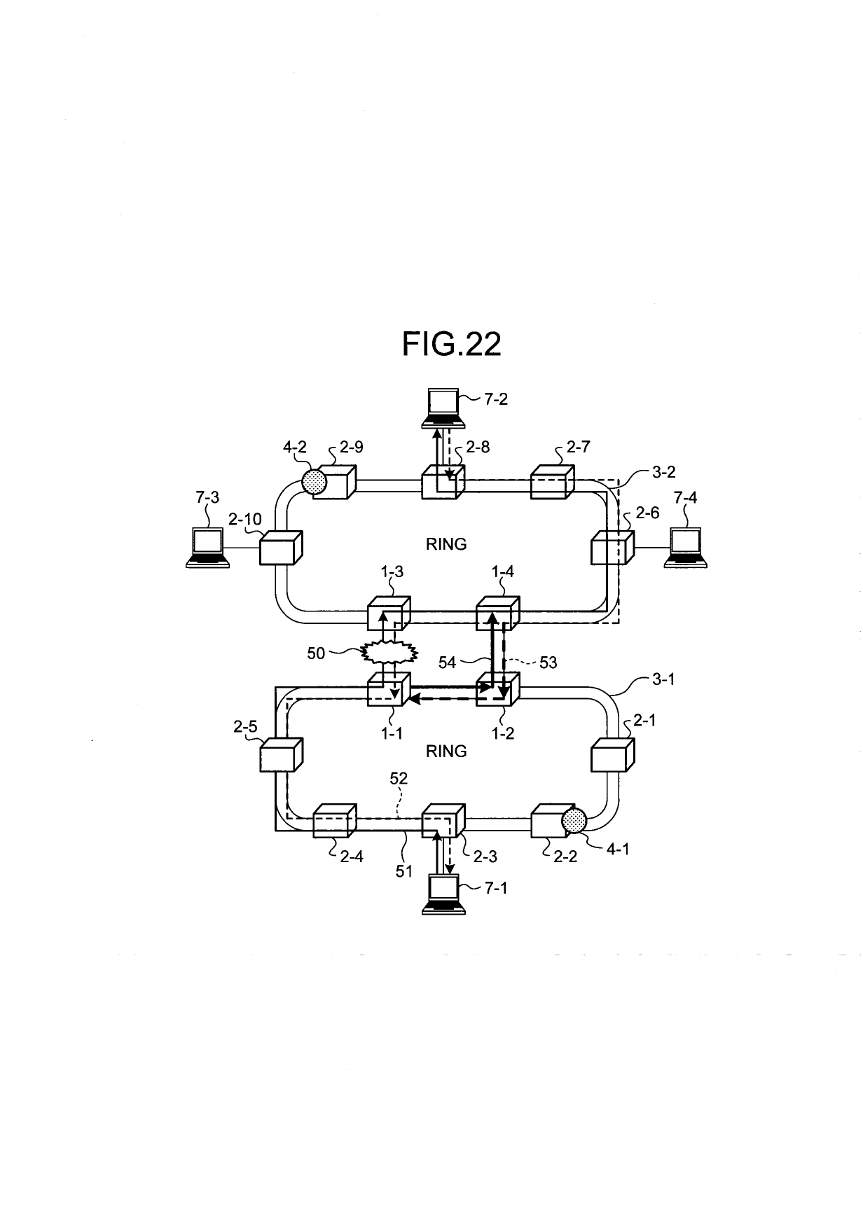

FIG. 22 is a configuration example of a communication system according to a third embodiment of the present invention. The communication system according to the present embodiment has the same configuration as that of the first embodiment and the nodes 1-1 to 1-4 have the same configurations as those in the first embodiment. In the present embodiment, an operation when a failure occurs in the inter-ring connection link 5-1 or 5-2 is explained.

An operation when no failure occurs in the present embodiment is the same as that in the first embodiment. It is assumed that an outward communication path 51 from the terminal 7-1 to the terminal 7-2 and a return communication path 52 are set by the operation described in the first embodiment. It is supposedly determined that a flow can pass through the inter-ring connection link 5-1 in a communication between the terminals 7-1 and 7-2, as in the first embodiment. It is assumed in this state that a failure 50 occurs in the inter-ring connection link 5-1.

The inter-ring connection-failure management units 18 of the nodes 1-1 and 1-2 detect the failure in the link 5-1. There is no restriction on a failure detection method and a failure may be detected by any method. For example, a failure is detected on the condition that a frame to be periodically transmitted does not arrive for more than a certain time, or the like condition.

The inter-ring connection-failure management unit 18 notifies a partner inter-ring connection node (the node 1-2 in the case of the node 1-1, and the node 1-4 in the case of the node 1-3) with which its own node forms a redundant pair together in the same ring, of the failure information, using a ring control frame that is a control frame to be used in the ring network (the ring 3-1 or 3-2) to which the own node belongs. Specifically, the inter-ring connection-failure management unit 18 generates the ring control frame, and instructs a ring port to which the partner inter-ring connection node of the redundant pair in the ring is connected, to forward the ring control frame to that ring port. Identification information of the partner inter-ring connection node of the redundant pair in the ring is previously set and a forwarding port corresponding to the partner inter-ring connection node of the redundant pair is known from the FDB.

Between opposite inter-ring connection nodes (between the nodes 1-1 and 1-3 or between the nodes 1-2 and 1-4), the failure information that is obtained from the ring control frame received from the partner inter-ring connection node of the redundant pair in the same ring is mutually provided with the failure information being set in a control frame to be used between the rings. Specifically, when, for example, the West-port I/F unit 14 of the node 1-2 receives an inter-ring control frame for notification of an inter-ring failure, transmitted from the node 1-1 through the West ring port 22, the node 1-2 generates a control frame for notification of occurrence of the failure in the link 5-1 for a control frame to be used between the rings, and forwards the generated control frame to the inter-ring connection port 21 via the frame multiplex-control unit 13, the inter-ring connection-port I/F unit 12, and the PHY unit 11. Similarly, the node 1-4 notifies the node 1-2 of the failure information that is obtained from the ring control frame received from the node 1-3 with setting the failure information in a control frame to be used between the rings.

Even when there is an instruction of forwarding to an inter-ring connection port on a path of failure as a result of the FDB search, the opposing pair of the failure-detecting nodes (pair of the nodes 1-1 and 1-3) changes the L2 forwarding rules to forward the frame only to the other inter-ring connection link of the inter-ring connection nodes. Specifically, when detecting failure occurrence in the inter-ring connection link to which the node itself is connected, the inter-ring connection-failure management unit 18 notifies the L2 forwarding unit 20 of the failure occurrence. When being notified of a port corresponding to the inter-ring connection link to which the node itself is connected as a forwarding destination as a result of the FDB search, the forwarding-port decision unit 202 of the L2 forwarding unit 20 determines a port corresponding to the other inter-ring connection node (the node 1-2 in the case of the node 1-1) in the same ring to be the forwarding destination of the frame.

Meanwhile, the opposing pair of the normal nodes (pair of the nodes 1-2 and 1-4) changes the L2 forwarding rules to rules in which all flows can pass through the link 5-2 to which the nodes themselves are connected, and rewrite the link pass information in the FDB, of which information that a flow can pass through the link 5-1 is changed in whole to information that a flow can pass through the link 5-2. Flows to be forwarded to the adjacent ring are all forwarded to the inter-ring connection link 5-2. Specifically, the forwarding-port decision unit 202 instructs that a frame using a node not included in its own ring as a destination should be forwarded to the inter-ring connection link to which its own node is connected.

With the operation mentioned above in the configuration example shown in FIG. 22, a circumvention path 53 corresponding to the communication path 52 and a circumvention path 54 corresponding to the communication path 51 are set, which enables communications that circumvent the failure point. In this case, it suffices only to change the L2 forwarding rules in the nodes 1-1 to 1-4 that art the inter-ring connection nodes, and changes in the FDBs of the other nodes 2-1 to 2-10 are unnecessary.

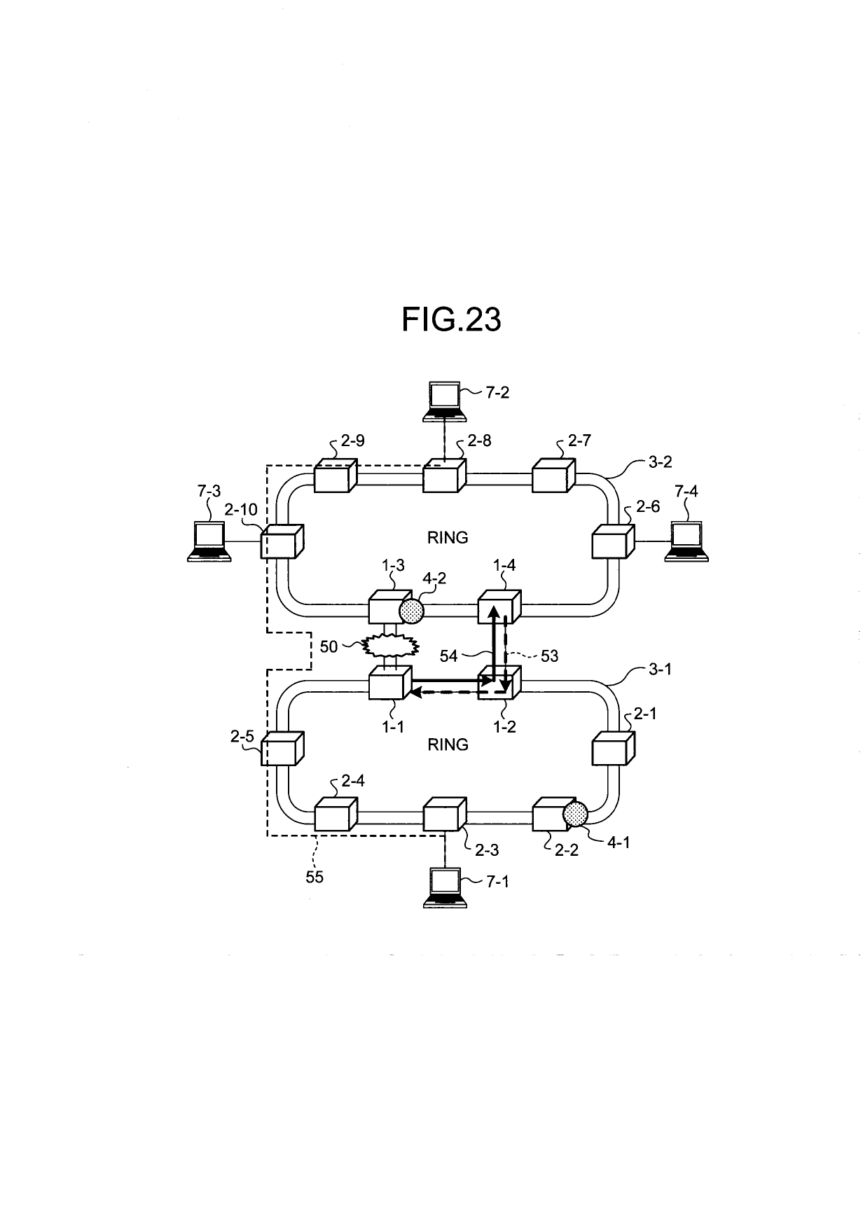

FIG. 23 is a configuration example in which a BP is set to an inter-ring connection node in the communication system according to the present embodiment. The configuration example shown in FIG. 23 is equal to the configuration example shown in FIG. 22 except that the BP 4-2 is set to the node 1-3 in the ring 3-2. A communication path 55 is set between the terminals 7-1 and 7-2 in the configuration example shown in FIG. 23. That is, it is set that a flow between the terminals 7-1 and 7-2 can pass through the link 5-1. Unlike the example shown in FIG. 22, the communication path 55 passes from the node 1-3 through the nodes 2-10 and 2-9 in the ring 3-2 because the BP 4-2 is set to the node 1-3. It is assumed that the failure 50 occurs in the link 5-1 in this case.

In the nodes 1-1 to 1-4, the circumvention paths 53 and 54 are set by much the same operation as in the example shown in FIG. 22. However, a frame addressed to the terminal 7-2, which has been forwarded from the node 1-2 and arrived at the node 1-4, can not arrive at the terminal 7-2 through the node 1-3 because the BP 4-2 is set to the node 1-3. For this reason, in order to enable the frame addressed to the terminal 7-2, which has been forwarded from the node 1-2 and arrived at the node 1-4, to be forwarded to the terminal 7-2 in the ring 3-2, a path is required to be restructured with FDB flush.

As for a direction from the terminal 7-2 to the terminal 7-1, it suffices that the node 1-2 forwards a frame, which has been forwarded from the node 1-4, to the node 1-1. That is, it suffices to perform FDB flush for the nodes 1-1 to 1-4, and there is no need to perform FDB flush for the other nodes 2-1 to 2-5 in the ring 3-1.

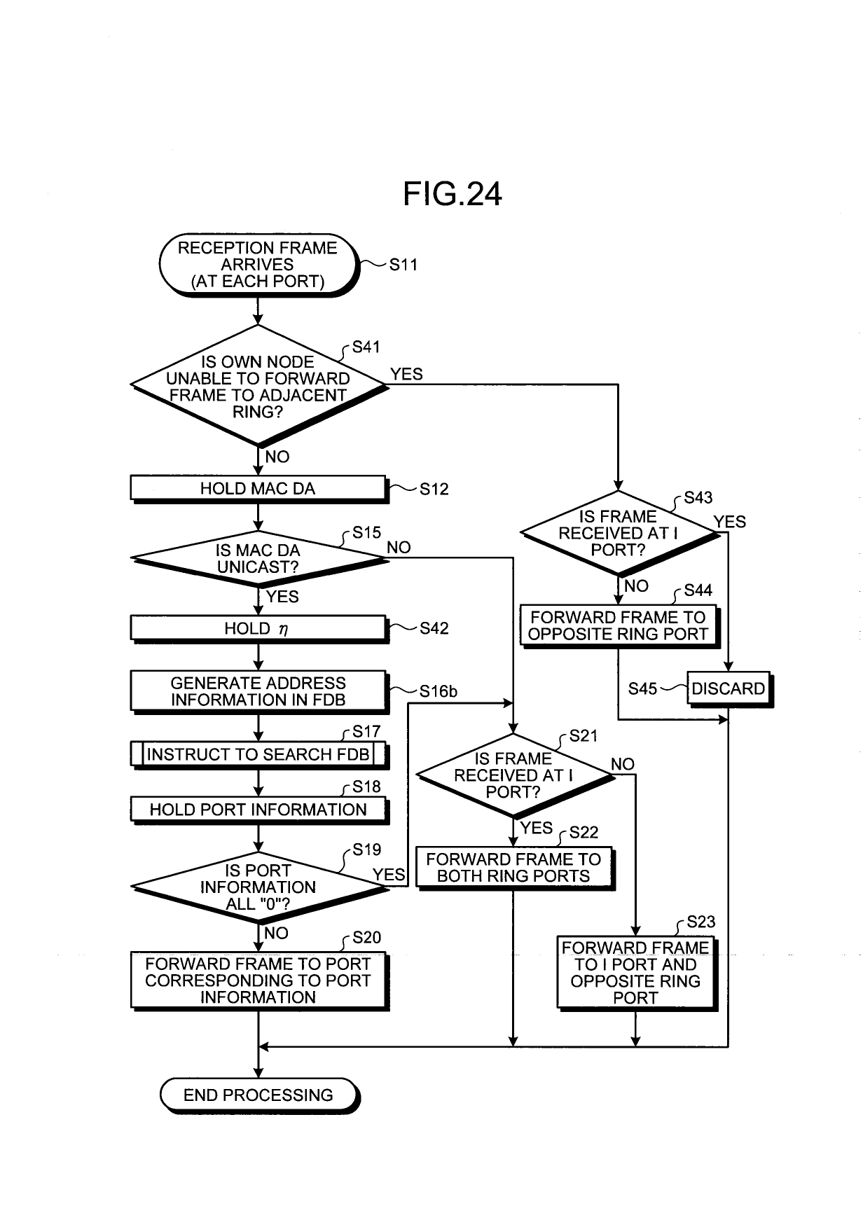

FIG. 24 is a flowchart of an example of an L2 forwarding procedure when a failure occurs in an inter-ring connection link in the present embodiment. FIG. 24 depicts operations of the nodes 1-1 to 1-4 when the inter-ring connection-failure management unit 18 of the corresponding node detects a failure in an inter-ring connection link connected to the node itself or when the inter-ring connection-failure management unit 18 receives from a partner inter-ring connection node of a redundant pair in the same ring, a control frame for failure notification notifying that a failure is detected in an inter-ring connection link to which the partner node is connected. It is assumed that the forwarding-destination-port decision unit 202 is notified of the failure in the inter-ring connection link (the inter-ring connection link to which the node itself is connected or the inter-ring connection link to which the other node is connected) from the inter-ring connection-failure management unit 18 or a port I/F unit having received the control frame for failure notification.

When receiving a frame after notification of failure occurrence in an inter-ring connection link (Step S11), the forwarding-destination-port decision unit 202 determines whether or not the node itself is unable to forward the frame to an adjacent ring, (that is, when it is determined that the node itself is not unable to forward the frame to an adjacent ring (NO at Step S41), whether or not a destination address of the reception frame is unicast (Step S15). The forwarding-destination-port decision unit 202 then holds the destination address of the reception frame (Step S12). When the destination address is unicast (YES at Step S15), destination address of the reception frame and identification information of the inter-ring connection link to which the own node is connected (the forwarding-destination-port decision 202 holds identification information (η) indicating an inter-ring connection link to which the node itself is connected (Step S42), and generates address information including the destination address and η (Step S16b).

The forwarding-destination-port decision unit 202 instructs the address-search processing unit 206 to search the FDB by the generated address information (Step S17). Subsequent Steps S18 to S23 are the same as Steps S18 to S23 in the first embodiment.

When it is determined at Step S41 that the node itself is unable to forward the frame to the adjacent ring (YES at Step S41), the forwarding-destination-port decision unit 202 determines whether or not the reception port is the inter-ring connection port 21 (Step S43). When the reception port is not the inter-ring connection port 21 (NO at Step S43), the forwarding-destination-port decision unit 202 determines a forward destination of the reception frame to be a port opposite to the reception port, instructs the corresponding port I/F unit to forward the reception frame through the determined port (Step S44), and ends the processing.

When the reception port is the inter-ring connection port 21 (YES at Step S43), the reception frame is discarded (Step S45) and the processing is ended. The forwarding-destination-port decision unit 202 determines on the forwarding destination of the reception port to be a port opposite to the reception port, and instructs the corresponding port I/F unit to forward the reception frame through the determined port (Step S44).

A method of performing FDB flush according to the present embodiment is explained next. When the conventional technique is applied as it is, the FDB flush is performed in both rings at the time of failure occurrence shown in FIG. 22 and also at the time of failure occurrence shown in FIG. 23. Practically, however, the FDB flush is not required in some situations as described above. Therefore, in the present embodiment, the FDB-flush determination unit 203 determines, in each of the nodes 1-1 to 1-4, whether or not to perform the FDB flush in its own ring based on whether or not a BP is set at the node itself when a failure occurs in the inter-ring connection link 5-1 or 5-2.

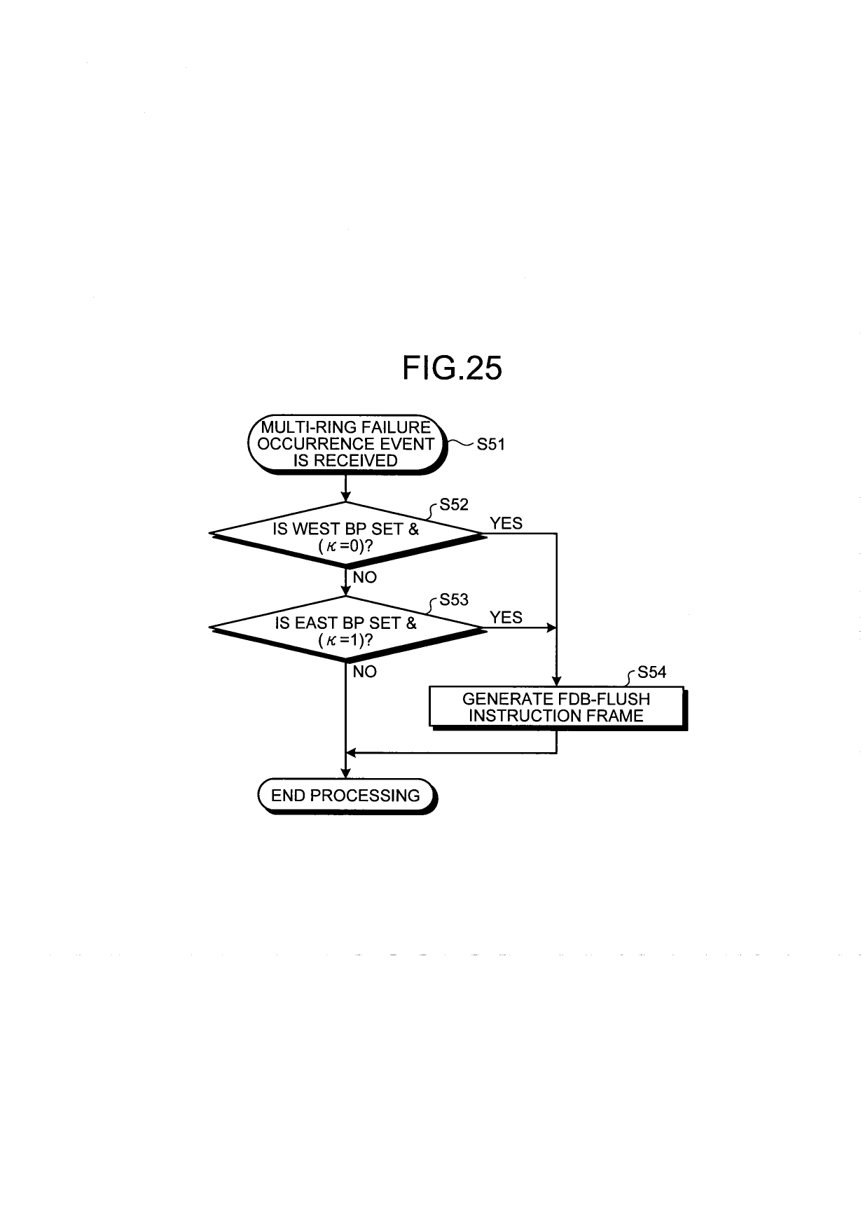

FIG. 25 is a flowchart of an example of an FDB-flush-performance determination processing procedure. When detecting a failure in an inter-ring connection link to which the node itself is connected, from the inter-ring connection-failure management unit 18, the FDB-flush determination unit 203 is notified of the detection of the failure. When receiving a notification of the failure detection in the inter-ring connection link to which the node itself is connected (upon reception of a multi-ring failure occurrence event) (Step S51), the FDB-flush determination unit 203 determines whether or not the West ring port 22 of the node itself is set for a BP and a direction of the other inter-node connection node in the same ring is the direction of the West ring port 22 (Step S52). For example, assuming in this case that an identifier indicating a direction of the other inter-node connection node in the same ring is κ, a direction of the other inter-node connection node in the same ring is a direction of the West ring port 22 when κ=0, whereas a direction of the other inter-node connection node in the same ring is a direction of the East ring port 23 when κ=1.

When “the West ring port of the node itself is set for a BP and a direction of the other inter-node connection node in the same ring is the direction of the West ring port” does not hold true (NO at Step S52), it is determined whether or not the East ring port 23 of the node itself is set for a BP and a direction of the other inter-node connection node in the same node is the direction of the East ring port 23 (Step S53). When “the East ring port 23 of the node itself is set for a BP and a direction of the other inter-node connection node in the same ring is the direction of the East ring port 23” does not hold true (NO at Step S53), the FDB flush in its own ring is not performed and the processing is ended.

At Step S53, when the West ring port 22 of the node itself is set for a BP and a direction of the other inter-node connection node in the same ring is the direction of the West ring port 22 (YES at Step S52), information for generating an FDB-flush instruction frame that instructs to perform the FDB flush in its own ring is generated and outputted to the West-port I/F unit 14 and the East-port I/F unit 15 (Step S54), and then the processing is ended. The West-port I/F unit 14 and the East-port I/F unit 15 forwards the frame instructing to perform the FDB flush to its own ring based on the input information. An event type of an Ring Automatic Protection Switching (R-APS) frame according to ERP standards or a vendor specific message (VSM) frame may be used for the instruction notification of the FDB flush to the own ring.

At Step S53, when the East ring port 23 of the node itself is set for a BP and a direction of the other inter-node connection node in the same ring is the direction of the East ring port 23 (YES at Step S53), the processing proceeds to Step S54.

While the example in which an operation performed in a case where no failure occurs is the same as that in the first embodiment has been explained in the present embodiment, the operation at the time of failure occurrence as in the present embodiment may be performed with an operation performed in a case where no failure occurs being the same as that in the second embodiment.

While the case where there are two pairs that are the opposing pairs of inter-ring connection nodes has been explained in the present embodiment, the same operation as in the present embodiment can be performed also in the case of three or more pairs by changing the L2 forwarding rules to permit flows that have passed through an inter-ring connection link in which a failure occurs to pass through another inter-ring connection link. For example, a substitute link is determined in advance for each of the inter-ring connection links and, when a failure occurs in an inter-ring connection link, a flow having been permitted to pass through the failure-occurring link is changed to a flow capable of passing through the substitute link. Also in this case, the FDB flush can be selectively performed, and it suffices to perform the FDB flush in a corresponding ring when a BP is set to its own node and a substitute inter-node connection node is located on the side of a port to which the BP is set. When there are three or more pairs, a flow having been forwarded through an inter-ring connection link in which a failure occurs may be forwarded using two or more inter-ring connection links other than the failure-occurring inter-ring connection link.

As described above, in the present embodiment, when a failure occurs in an inter-ring connection link, the forwarding rules are changed such that inter-ring connection nodes having no failure can forward all flows, and inter-ring connection nodes having the failure cause a flow that has been forwarded using the failure-occurring inter-ring connection link to be forwarded to the other inter-ring connection node in the same ring. Accordingly, the same effect as in the first embodiment is achieved and also a circumvention path can be promptly set even at the time of occurrence of a failure in an inter-ring connection link.

Furthermore, an inter-ring connection node to which a BP is set and has detected a failure in an inter-ring connection link to which the node itself is connected instructs that the FDB flush should be performed in the node itself when the other inter-node connection node in the same ring is located on the side of a port to which the BP is set. Accordingly, frequency of unlearned states caused by the FDB flush is decreased and also unwanted traffics over the entire network due to Flooding are reduced. Therefore, reduction in performance due to occurrence of competition in transmission to a traffic that requires a real-time property can be avoided at the time of failure path switching. For example, when an inter-ring connection node is disengaged and then rearranged, the FDB flush is not performed, and so a network operation that does not affect the entire network can be achieved.

### INDUSTRIAL APPLICABILITY

As described above, the communication device, the communication system and the communication method according to the present invention are useful for a communication system that configures a multiring network, and are particularly suitable for a communication system including a plurality of pairs of opposing inter-ring connection nodes.

### REFERENCE SIGNS LIST

1-1 to 1-4, 2-1 to 2-10 node
3-1, 3-2 ring
4-1, 4-2 BP
5-1, 5-2 link
6 redundant pair
7-1 to 7-5 terminal
11, 16, 17 PHY unit
12 inter-ring connection-port I/F unit
13 frame multiplex-control unit
14 West-port I/F unit
15 East-port I/F unit
18 inter-ring connection-failure management unit
19 ring-failure management unit
20, 20a L2 forwarding unit
21 inter-ring connection port
22 West ring port
23 East ring port
201, 201a flow-information-pass determination unit
202, 202a forwarding-destination-port decision unit
203 FDB-flush determination unit
204, 204a address-learning processing unit
205, 205a FDB management unit
206, 206a address-search processing unit
31 to 40 flow
50 failure
51, 52, 55 communication path
53, 54 circumvention path

1. A communication device that functions in a communication system including a plurality of inter-ring connection links that are each connected between adjacent ring networks and validly operate, as an inter-ring connection node connected to the inter-ring connection link, the communication device comprising:
a pass-link decision unit that, based on rules for determining an inter-ring connection link through which a frame exclusively passes from the inter-ring connection links indicated by a flow which is stored in a reception frame and to which the frame belongs, determines whether or not the frame passes through the inter-ring connection link; and
a forwarding-destination decision unit that, in the case where a destination of the reception frame is a destination in an adjacent ring network or a destination to be reached through an adjacent ring network, when the inter-ring connection link decided by the pass-link decision unit is an inter-ring connection link to which an own node is connected, decides that a forwarding destination of the frame is the inter-ring connection link to which the own node is connected.

2. The communication device according to claim 1, comprising two ring ports that connect in directions of two adjacent communication devices, respectively, in an own ring network, wherein
the forwarding-destination decision unit decides, in the case where a destination of the reception frame is in an adjacent ring network, that a forwarding destination of the reception frame is a ring port opposite to a ring port that has received the reception frame when the inter-ring connection link decided by the pass-link decision unit is not an inter-ring connection link to which the own node is connected.

3. The communication device according to claim 1, wherein rules of the pass-link decision unit for deciding an inter-ring connection link through which the frame passes are set to be same as rules for deciding an inter-ring connection link through which the frame passes in the other inter-ring connection node in an own ring network.

4. The communication device according to claim 1, wherein rules of the pass-link decision unit for deciding an inter-ring connection link through which the frame passes are set to be same as rules for deciding an inter-ring connection link through which the frame passes in an opposite inter-ring connection node connected to the inter-ring connection link to which the own node is connected.

5. The communication device according to claim 3, which is adapted to exchange rules for deciding an inter-ring connection link through which the frame passes with the other inter-ring connection node, and to determine that forwarding to the inter-ring connection link connected to the own node is possible when the rules held therein are same as rules provided from the other inter-ring connection node and not to perform forwarding to the inter-ring connection link connected to the own node when the rules held therein are different from the rules provided from the other inter-ring connection node.

6. The communication device according to claim 1, further comprising an FDB management unit that holds a forwarding database having addresses and ports corresponding thereto stored therein, wherein
pass link information indicating an inter-ring connection link decided by the pass-link decision unit is also stored in the forwarding database, and, when a reception frame is to be forwarded to a destination having a learned address, the forwarding database is searched based on the address and a decision result decided by the pass-link decision unit for the reception frame to obtain a forwarding destination port.

7. The communication device according to claim 6, wherein a plurality of entries having different decision results decided by the pass-link decision unit are stored in the forwarding database in association with one and the same address.

8. The communication device according to claim 6, wherein different ports are stored per decision result decided by the pass-link decision unit in one entry corresponding to one address of the forwarding database.

9. The communication device according to claim 1, wherein the flow information includes a transmission source address and a destination address.

10. The communication device according to claim 1, further comprising an inter-ring connection-failure management unit that detects a failure in the inter-ring connection link to which the own node is connected, wherein
when the inter-ring connection-failure management unit detects a failure, the failure is transmitted as an inter-ring connection failure notification to the other inter-ring connection node in the own ring network and a reception frame whose destination is in an adjacent ring network is forwarded to the other inter-ring connection node in the own ring network after detection of the failure, and when an inter-ring connection failure notification provided from the other inter-ring connection node is received, at least some of flows for which the inter-ring connection link decided by the pass-link decision unit is an inter-ring connection link in which the inter-ring connection failure occurs are forwarded using the inter-ring connection link to which the own node is connected.

11. The communication device according to claim 10, further comprising an FDB-flush determination unit that determines whether or not to perform flush of the forwarding database in the own ring network when the inter-ring connection-failure management unit detects a failure.

12. The communication device according to claim 11, wherein the FDB-flush determination unit determines whether or not to perform flush of the forwarding database in the own ring network based on a BP set position and a position of the other inter-ring connection node in the own ring network.

13. A communication system comprising:
two or more ring networks;
two or more inter-ring connection links that are each connected between adjacent ones of the ring networks and validly operate; and
the communication device according to claim 1 that is connected to the inter-ring connection link.

14. A communication method in a communication device that functions in a communication system including a plurality of inter-ring connection links that are each connected between adjacent ring networks and validly operate, as an inter-ring connection node connected to the inter-ring connection link, the communication method comprising:
a pass-link decision step of, based on rules for determining an inter-ring connection link through which a frame exclusively passes from the inter-ring connection links indicated by a flow which is stored in a reception frame and to which the frame belongs, determining whether or not the frame passes through the inter-ring connection link; and
a forwarding-destination decision step of, in the case where a destination of the reception frame is a destination in an adjacent ring network or a destination to be reached through an adjacent ring network, when the inter-ring connection link decided at the pass-link decision step is an inter-ring connection link to which an own node is connected, deciding that a forwarding destination of the frame is the inter-ring connection link to which the own node is connected.

15. The communication device according to claim 4, which is adapted to exchange rules for deciding an inter-ring connection link through which the frame passes with the other inter-ring connection node, and to determine that forwarding to the inter-ring connection link connected to the own node is possible when the rules held therein are same as rules provided from the other inter-ring connection node and not to perform forwarding to the inter-ring connection link connected to the own node when the rules held therein are different from the rules provided from the other inter-ring connection node.
